(19) United States
(12) Patent Application Publication
(10) Pub. No.: US 2013/0274149 A1
(43) Pub. Date: Oct. 17, 2013

(54) FLUIDS AND METHODS INCLUDING NANOCELLULOSE

(71) Applicant: SCHLUMBERGER TECHNOLOGY CORPORATION, Sugar Land, TX (US)

(72) Inventors: Valerie Lafitte, Stafford, TX (US); Jesse C. Lee, Sugar Land, TX (US); Syed A. Ali, Sugar Land, TX (US); Philip F. Sullivan, Bellaire, TX (US)

(73) Assignee: SCHLUMBERGER TECHNOLOGY CORPORATION, Sugar Land, TX (US)

(21) Appl. No.: 13/834,841

(22) Filed: Mar. 15, 2013

Related U.S. Application Data
(60) Provisional application No. 61/624,038, filed on Apr. 13, 2012.

(51) Int. Cl. C09K 8/90; C09K 8/10

(52) U.S. Cl. CPC C09K 8/905; C09K 8/10
USPC 507/112; 507/214; 106/805; 166/292

(57) ABSTRACT

Treatment fluids and methods for treating a subterranean formation are disclosed that include introducing a treatment fluid into a subterranean formation, the treatment fluid containing a nanocrystalline cellulose.

### CROSS REFERENCE

This application claims the benefit of a related U.S. Provisional Application Ser. No. 61/624,038, which was filed on Apr. 13, 2012, entitled “METHODS OF USING NANOCELLULOSE IN VARIOUS OILFIELD APPLICATIONS,” to Lafitte et al., the disclosure of which is incorporated herein by reference in its entirety.

### BACKGROUND

Hydrocarbons (oil, natural gas, etc.) may be obtained from a subterranean geologic formation (a “reservoir”) by drilling a well that penetrates the hydrocarbon-bearing formation. Well treatment methods often are used to increase hydrocarbon production by using a chemical composition or fluid, such as a treatment fluid.

The use of treatment fluids containing environmentally friendly materials in oilfield industries is desirable as most chemical compositions that are not considered environmentally friendly or “green” may have potential harmful effects on both persons and/or the environment. To address this issue, “green” chemical replacements are often desired.

Cellulose fibers and their derivatives constitute one of the most abundant renewable polymer resources available on earth. Recently, research regarding one form of nanocellulose (NC), called nanocrystalline cellulose (NCC), but can also be called cellulose nanocrystals, or nanocellulose whiskers has become increasingly popular, particularly because of its renewability and sustainability. NCC can be extracted from the cellulose microfibrils them self-derived from various cellulosic sources (for example, wood pulp, cotton, soft wood, hard wood) by acid hydrolysis of the amorphous regions. The resulting crystalline nanoparticles are exceptionally rigid, rod-shape like with high surface area. The hydrolysis treatment has a direct influence on the dimensions, stability and yield of the NCC produced. In particular, the use of sulfuric acid over hydrochloric acid will increase the surface charges (sulfates groups) on the NCC, which will lead to much more stable colloidal suspensions in water. In addition to the charged groups present at the surface of the NCC derived from the Hydrolysis treatment, NCC has available hydroxyl groups that can be further functionalized to make a more compatible material with a specific matrix (for example, a nanocomposite) or render to the NCC a desired property to be useful for specific oilfield applications. The abundance of hydroxyl groups at the NCC surface allows for various chemical modifications to be performed, which allows these materials to be tailored to perform a desired function and/or desired purpose in various oilfield applications.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter. In some embodiments, the present disclosure relates to a fluid for treating a subterranean formation including a solvent and a composition containing a nanocrystalline cellulose. In some embodiments, the present disclosure relates to a method for treating a subterranean formation, the method including preparing a treatment fluid containing a solvent, and a nanocrystalline cellulose; and introducing the treatment fluid into a wellbore.

### BRIEF DESCRIPTION OF THE DRAWINGS

The manner in which the objectives of the present disclosure and other desirable characteristics may be obtained is explained in the following description and attached drawings in which:

FIG. 1 is an illustration of the results of various single grain static sand settling experiments conducted with nanocellulose samples;

FIG. 2 shows a plot of the viscosity as a function the shear rate for a sample containing a blend of guar and NCC;

FIG. 3 is an illustration of the temperature stability of the rheology properties of a blend of guar and NCC;

FIG. 4 shows a plot of the viscosity measured as a function of shear rate for samples containing CMC and/or NCC;

FIG. 5 shows a plot of the viscosity measured as a function of temperature for samples containing viscos-elastic surfactants mixed with NCC; and

FIG. 6 shows a plot of the viscosity measured as a function of shear rate for samples containing viscos-elastic surfactants mixed with NCC.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The methods of the present disclosure relate to introducing fluids comprising a nanocrystalline cellulose (NCC), such as a treatment fluid comprising an NCC and/or an NCC particle, into a subterranean formation. Such treatment fluids may be introduced during methods that may be applied at any time in the life cycle of a reservoir, field or oilfield; for example, the methods and treatment fluids of the present disclosure may be employed in any desired downhole application (such as, for example, stimulation) at any time in the life cycle of a reservoir, field or oilfield.

The term “treatment fluid,” refers to any fluid used in a subterranean operation in conjunction with a desired function and/or for a desired purpose. The term “treatment,” or “treating,” does not imply any particular action by the fluid. For example, a treatment fluid (such as a treatment fluid comprising an NCC) introduced into a subterranean formation subsequent to a leading-edge fluid may be a hydraulic fracturing fluid, an acidizing fluid (acid fracturing, acid diverting fluid), a stimulation fluid, a sand control fluid, a completion fluid, a wellbore consolidation fluid, a remediation treatment fluid, a cementing fluid, a drilling fluid, a spacer fluid, a frac-packing fluid, or gravel packing fluid. The methods of the present disclosure in which an NCC is employed, and treatment fluids comprising an NCC may be used in full-scale operations, pills, or any combination thereof. As used herein, a “pill” is a type of relatively small volume of specially prepared treatment fluid, such as a treatment fluid comprising an NCC, placed or circulated in the wellbore.

The term “fracturing” refers to the process and methods of breaking down a geological formation and creating a fracture, such as the rock formation around a wellbore, by pumping fluid at very high pressures (pressure above the determined closure pressure of the formation), in order to increase production rates from or injection rates into a hydrocarbon reservoir. The fracturing methods of the present disclosure may include an NCC in one or more of the treatment fluids, but otherwise use conventional techniques known in the art.

In embodiments, the treatment fluids of the present disclosure may be introduced into a wellbore. A “wellbore” may be any type of well, including, but not limited to, a producing well, a non-producing well, an injection well, a fluid disposal well, an experimental well, an exploratory well, and the like. Wellbores may be vertical, horizontal, deviated some angle between vertical and horizontal, and combinations thereof, for example a vertical well with a non-vertical component.

The term “field” includes land-based (surface and sub-surface) and sub-seabed applications. The term “oilfield,” as used herein, includes hydrocarbon oil and gas reservoirs, and formations or portions of formations where hydrocarbon oil and gas are expected but may additionally contain other materials such as water, brine, or some other composition.

The term “treating temperature,” refers to the temperature of the treatment fluid that is observed while the treatment fluid is performing its desired function and/or desired purpose.

The term “surface-functionalizing” refers, for example, to the process of attaching (via a covalent or ionic bond) a functional group or chemical moiety onto a surface of an NCC.

The phrase “surface of the nanocrystalline cellulose” refers, for example, to the outer circumferential areas of an NCC particle, such as, for example, outer circumferential areas of an NCC particle that contains moieties that are suitable to participate in chemical reactions.

The term “moiety” and/or “moieties” refer, for example, to a particular functional group or part of a molecule, such as, for example, the closely-packed hydroxyl moieties on the surface of an NCC.

The term “surface modifier” refers, for example, to a substance, such as a chemical moiety, that attaches or is attached onto a surface of an NCC. Such attachment may be by esterification, etherification, acetylation, silylation, oxidation, grafting polymers on the surface, functionalization with various chemical moieties (such as with a hydrophobic group), and noncovalent surface modification, such as adsorbing surfactants, which may interact via a hydroxyl group, sulfate ester group, carboxylate groups, halides, ethers, aldehydes, keytones, esters, amines and/or amides.

The term “mild conditions” refers, for example, to experimental conditions, such as hydrolysis conditions, that are gentle such that they do not result in any considerable degradation or decomposition (such as where the outer circumference of the nanocrystalline cellulose has been completely consumed or hydrolysed, and/or where about 5% by weight of the nanocrystalline cellulose has been consumed or hydrolysed) of the NCC particles. Hydrolysis conditions may refer to the type of acid, concentration, duration of hydrolysis, and temperature. The hydrolysis may be controlled in order to achieve desirable properties. The hydrolysis conditions to which the cellulose is exposed may define the shape, degree of crystallinity and yield of the resulting NCC, which may be NCC particles having a specific shape, including, for example, a rod-like crystalline nanoparticle. For example, if the hydrolysis is not complete, an amorphous phase may still be present leading to longer particles, but if the hydrolysis is too harsh (for example, longer time, high temperature) then some crystalline domain may start to be consumed. In embodiments, when the cellulose from which the NCC particle is derived is exposed to mild conditions the NCC crystalline structure may not disrupted and the original NCC shape is preserved. In embodiments, the use of mild conditions results in a NCC particle in which the outer circumference of the nanocrystalline cellulose has not been consumed.

The term “homogeneity” refers, for example, to a characteristic property of compounds and elements. The term may be used to describe a mixture or solution composed of two or more compounds or elements that are uniformly dispersed in each other.

The term “amorphous region” refers, for example, to areas of a material such as, for example, a cellulose fiber, characterized as having no molecular lattice structure or having a disordered or not well-defined crystalline structure, resulting in a low resistance to acid attack.

The term “paracrystalline region” refers, for example, to areas of a material such as, for example, a cellulose fiber, that is characterized as having a structure that is partially amorphous and partially crystalline, but not completely one or the other, resulting in a slightly higher resistance to acid attack as compared with amorphous regions of a material.

The term “crystalline region” refers, for example, to areas of a material such as, for example, a cellulose fiber, that has a solid characteristic with a regular, ordered arrangement of particles resulting in a high resistance to acid attack.

The phrase “aqueous NCC dispersion” refers, for example, to a two-phased system that is made up of NCC particles that are uniformly distributed throughout an aqueous matrix. Upon distribution, the NCC particles may form a single-phase colloidal suspension.

The term “mesh” as used herein means the Tyler mesh size. The Tyler mesh size is a scale of particle size in powders. The particle size can be categorized by sieving or screening, that is, by running the sample through a specific sized screen. The particles can be separated into two or more size fractions by stacking the screens, thereby determining the particle size distribution.

Nanocellulose

Nanocellulose may refer to at least three different types of nanocellulose materials, which vary depending on the fabrication method and the source of the natural fibers. These three types of nanocellulose materials are called nanocrystalline cellulose (NCC) microfibrillated cellulose (MFC), and bacterial cellulose (BC), which are described below. Additional details regarding these materials are described in U.S. Pat. Nos. 4,341,807, 4,374,702, 4,378,381, 4,452,721, 4,452,722, 4,464,287, 4,483,743, 4,487,634 and 4,500,546, the disclosures of each of which are incorporated by reference herein in their entirety.

Nanocellulose materials have a repetitive unit of β-1,4 linked D glucose units, as seen in the following chemical structure:

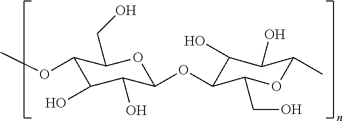

The integer values for the variable n relate to the length of the nanocellulose chains, which generally depends on the source of the cellulose and even the part of the plant containing the cellulose material.

In some embodiments, n may be an integer of from about 100 to about 10,000, from about 1,000 to about 10,000, or from about 1,000 to about 5,000. In other embodiments, n may be an integer of from about 5 to about 100. In other embodiments, n may be an integer of from about 5000 to about 10,000. In embodiments, the nanocellulose chains may have an average diameter of from about 1 nm to about 1000 nm, such as from about 10 nm to about 500 nm or 50 nm to about 100 nm.

Nanocrystalline cellulose (NCC), also referred to as cellulose nanocrystals, cellulose whiskers, or cellulose rod-like nanocrystals, can be obtained from cellulose fibers. However, cellulose nanocrystals may have different shapes besides rods. Examples of these shapes include any nanocrystal in the shape of a 4-8 sided polygon, such as, a rectangle, hexagon or octagon. NCCs are generally made via the hydrolysis of cellulose fibers from various sources such as cotton, wood, wheat straw and cellulose from algae and bacteria. These cellulose fibers are characterized in having two distinct regions, an amorphous region and a crystalline region. In embodiments, NCC can be prepared through acid hydrolysis of the amorphous regions of cellulose fibers that have a lower resistance to acid attack as compared to the crystalline regions of cellulose fibers. Consequently, NCC particles with “rod-like” shapes (herein after referred to as “rod-like nanocrystalline cellulose particles” or more simply “NCC particles”) having a crystalline structure are produced. In embodiments, the hydrolysis process may be conducted under mild conditions such that the process does not result in any considerable degradation or decomposition rod-like crystalline portion of the cellulose.

In some embodiments, NCC can be prepared through acid hydrolysis of the amorphous and disordered paracrystalline regions of cellulose fibers that have a lower resistance to acid attack as compared to the crystalline regions of cellulose fibers. During the hydrolysis reaction, the amorphous and disordered paracrystalline regions of the cellulose fibers are hydrolyzed, resulting in removal of microfibrils at the defects. This process also results in rod-like nanocrystalline cellulose particles or more simply “NCC particles” having a crystalline structure. In embodiments, the hydrolysis process may be conducted under mild conditions such that the process does not result in any considerable degradation or decomposition rod-like crystalline portion of the cellulose.

Consequently, NCC particles with “rod-like” shapes (herein after referred to as “rod-like nanocrystalline cellulose particles” or more simply “NCC particles”) having a crystalline structure are produced.

The NCC particles may be exceptionally tough, with a strong axial Young's modulus (150 GPa) and may have a morphology and crystallinity similar to the original cellulose fibers (except without the presence of the amorphous). In some embodiments, the degree of crystallinity can vary from about 50% to about 100%, such as from about 65% to about 85%, or about 70% to about 80% by weight. In some embodiments, the degree of crystallinity is from about 85% to about 100% such as from about 88% to about 95% by weight.

In embodiments, the NCC particles may have a length of from about 50 to about 500 nm, such as from about 75 to about 300 nm, or from about 50 to about 100 nm. In embodiments, the diameter of the NCC particles may further have a diameter of from about 2 to about 500 nm, such as from about 2 to about 100 nm, or from about 2 to about 10 nm. In embodiments, the NCC particles may have an aspect ratio (length:diameter) of from about 10 to about 100, such as from about 25 to about 100, or from about 50 to about 75.

Techniques that are commonly used to determine NCC particle size are scanning electron microscopy (SEM), transmission electron microscopy (TEM) and/or atomic force microsocopy (AFM). Wide angle X-ray diffraction (WAXD) may be used to determine the degree of crystallinity.

In some embodiments, the NCCs or NCC particles may have a surface that is closely packed with hydroxyl groups, which allows for chemical modifications to be performed on their surfaces. In embodiments, some of the hydroxyl groups of the NCC or NCC particles may have been modified or converted prior to, during, and/or after introduction into the wellbore, such as to a sulfate ester group, during acid digestion. In some embodiments, some of the hydroxyl groups of the NCC or NCC particles surface may have been modified or converted to be carboxylated.

In embodiments, the choice of the method to prepare the NCCs or NCC particles (and thus the resultant functional groups present on the surface of the NCCs or NCC particles) may be used to tailor the specific properties of the fluids comprising the NCCs or NCC particles. For example, fluids comprising NCCs or NCC particles may display a thixotropic behavior or antithixotropic behavior, or no time-dependent viscosity. For instance, fluids incorporating hydrochloric acid-treated NCCs or NCC particles may possess thixotropic behavior at concentrations above 0.5% (w/v), and antithixotropic behavior at concentrations below 0.3% (w/v), whereas fluids incorporating sulfuric acid treated NCCs or NCC particles may show no time-dependent viscosity.

In embodiments, the NCC or NCC particles may be functionalized to form a functionalized NCC particle, such as a functionalized NCC particle in which the outer circumference of the nanocrystalline cellulose has been functionalized with various surface modifiers, functional groups, species and/or molecules. For example, such chemical functionalizations and/or modifications may be conducted to introduce stable negative or positive electrostatic charges on the surface of NCCs or NCC particles. Introducing negative or positive electrostatic charges on the surface of NCCs or NCC particles may allow for better dispersion in the desired solvent or medium.

In embodiments, the NCC or NCC particles may be surface-only functionalized NCC or NCC particles in which only the outer circumference of the NCC or NCC particle has been functionalized with various surface modifiers, functional groups, species and/or molecules. In embodiments, the surface of the NCC or NCC particles may be modified, such as by removing any charged surface moieties under conditions employed for surface functionalization, in order to minimize flocculation of the NCC or NCC particles when dispersed in a solvent, such as an aqueous solvent.

Modification, such as surface-only modification, of the NCC or NCC particles, may be performed by a variety of methods, including, for example, esterification, etherification, acetylation, silylation, oxidation, grafting polymers on the surface, functionalization with various chemical moieties (such as with a hydrophobic group to improve compatibility with hydrocarbons and/or oil), and noncovalent surface modification, including the use of adsorbing surfactants and polymer coating, as desired. In embodiments, the surface functionalization process may be conducted under mild conditions such that the process does not result in any considerable degradation or decomposition rod-like nanocrystalline particles.

In embodiments, modification (such as surface-only modification) by grafting polymerization techniques may preserve the particle shape of the NCC or NCC particles. For example, the shape may be preserved by selecting a low molecular weight polymer, such as a polymer with a molecular weight not exceeding about 100,000 Daltons, or not exceeding about 50,000 Daltons, to be grafted onto the NCC particle surface.

In embodiments, chemical modifications may involve electrophiles that are site-specific when reacting with hydroxyl groups on NCC or NCC particle surfaces. For instance, such electrophiles may be represented by a general formula such as, for example, RX, where “X” is a leaving group that may include a halogen, tosylate, mesylate, alkoxide, hydroxide or the like, and “R” may contain alkyl, silane, amine, ether, ester groups and the like. In embodiments, surface functionalization with such electrophiles may be performed in a manner that does not decrease the size or the strength of the NCC or NCC particle.

In some embodiments, the NCC or NCC particle surfaces may have a percent surface functionalization of about 5 to about 90 percent, such as from of about 25 to about 75 percent, and or of about 40 to about 60 percent. In some embodiments, about 5 to about 90 percent of the hydroxyl groups on NCC or NCC particle surfaces may be chemically modified, 25 to about 75 percent of the hydroxyl groups on NCC or NCC particle surfaces may be chemically modified, or 40 to about 60 percent of the hydroxyl groups on NCC or NCC particle surfaces may be chemically modified.

Fourier Transform Infrared (FT-IR) and Raman spectroscopies and/or other known methods may be used to assess percent surface functionalization, such as via investigation of vibrational modes and functional groups present on the NCC or NCC particles. Additionally, analysis of the local chemical composition of the cellulose, NCC or NCC particles may be carried out using energy-dispersive X-ray spectroscopy (EDS). The bulk chemical composition can be determined by elemental analysis (EA). Zeta potential measurements can be used to determine the surface charge and density. Thermal gravimetric analysis (TGA) and differential scanning calorimetry (DSC) can be employed to understand changes in heat capacity and thermal stability.

Micro Fibrillated Cellulose (MFC), or nanofibrils, is a form of nanocellulose derived from wood products, sugar beet, agricultural raw materials or waste products. In MFC, the individual microfibrils have been incompletely or totally detached from each other. For example, the microfibrillated cellulose material has an average diameter of from about 5 nm to about 500 nm, from about 5 nm to about 250 nm, or from about 10 nm to about 100 nm. In some embodiments, the microfibrillated cellulose material may have an average diameter of from about 10 nm to about 60 nm. Furthermore, in MFC, the length may be up to 1 μm, such as from about 500 nm to about 1 μm, or from about 750 nm to about 1 μm. The ratio of length (L) to diameter (d) of the MFC may be from about 50 to about 150, such as from about 75 to about 150, or from about 100 to about 150.

One common way to produce MFC is the delamination of wood pulp by mechanical pressure before and/or after chemical or enzymatic treatment. Additional methods include grinding, homogenizing, intensification, hydrolysis/electrospinning and ionic liquids. Mechanical treatment of cellulosic fibers is very energy consuming and this has been a major impediment for commercial success. Additional manufacturing examples of MFC are described in WO 2007/091942, WO 2011/051882, U.S. Pat. No. 7,381,294 and U.S. Patent Application Pub. No. 2011/0036522, each of which is incorporated by reference herein in their entirety.

MFC may be similar in diameter to the NCC particle, but MFC is more flexible because NCC particles have a very high crystalline content (which limits flexibility). For example, in contrast to the high crystalline content of NCC particles, which may be homogeneously distributed or constant throughout the entire NCC particle, MFCs contain distinct amorphous regions, such as amorphous regions that alternate with crystalline regions, or amorphous regions in which crystalline regions are interspersed. Additionally, MFCs possess little order on the nanometer scale, whereas NCC and/or NCC particles are highly ordered. Furthermore, the crystallinity of MFCs may approach 50%, whereas the crystallinity of NCCs is higher and will depend on the method of production.

Bacterial nanocellulose is a material obtained via a bacterial synthesis from low molecular weight sugar and alcohol for instance. The diameter of this nanocellulose is found to be about 20-100 nm in general. Characteristics of cellulose producing bacteria and agitated culture conditions are described in U.S. Pat. No. 4,863,565, the disclosure of which is incorporated by reference herein in its entirety. Bacterial nanocellulose particles are microfibrils secreted by various bacteria that have been separated from the bacterial bodies and growth medium. The resulting microfibrils are microns in length, have a large aspect ratio (greater than 50) with a morphology depending on the specific bacteria and culturing conditions.

Applications of NCCs and NCC Particles

As discussed above, in embodiments, the methods of the present disclosure relate to the use of NCCs and/or NCC particles in multiple oilfield applications. For example, NCCs and/or NCC particles may be used as an additive in conventional well treatment fluids used in fracturing, cementing, sand control, shale stabilization, fines migration, drilling fluid, friction pressure reduction, loss circulation, well clean out, and the like. In some embodiments, the fluids, treatment fluids, or compositions of the present disclosure may comprise one or more NCCs and/or NCC particles for the above-mentioned uses in an amount of from about 0.001 wt % to 10 wt %, such as, about 0.01 wt % to about 10 wt %, about 0.1 wt % to about 5 wt %, or of from about 0.5 wt % to about 5 wt % based on the total weight of the fluid, treatment fluid, or composition.

For example, NCCs and/or NCC particles may also be used in well treatment fluids as, for example, a viscosifying agent, proppant transport agent, a material strengthening agent (such as for structural reinforcement for cementing), a fluid loss reducing agent, friction reducer/drag reduction agent and/or gas mitigation agent. Surface modification of the NCCs and/or NCC particles may be employed to enhance or attenuate one or more of the properties of the NCCs and/or NCC particles in conjunction with the above uses, as desired. In embodiments, the fluids, treatment fluids, or compositions of the present disclosure may comprise one or more NCCs and/or NCC particles as the above-mentioned agents in an amount of from about 0.001 wt % to about 10 wt %, 0.01 wt % to 10 wt %, such as 0.1 wt % to 5 wt %, or of from about 0.5 wt % to about 5 wt % based on the total weight of the fluid, treatment fluid, or composition.

Regarding cementing, NCCs and/or NCC particles may be used to stabilized foamed cement slurry, as an additive for cement composite, to mitigate gas migration, to stabilize cement slurries and/or as an additive to reinforce a wellbore and/or a cement column. Surface modification of the NCCs and/or NCC particles may be employed to enhance or attenuate one or more of the properties of the NCCs and/or NCC particles in conjunction with the above uses, as desired. In some embodiments, the fluids, treatment fluids, or compositions of the present disclosure may comprise one or more NCCs and/or NCC particles for the above-mentioned uses in an amount of from about 0.001 wt % to about 10 wt %, such as 0.01 wt % to 10 wt %, 0.1 wt % to 5 wt %, or of from about 0.5 wt % to about 5 wt % based on the total weight of the fluid, treatment fluid, or composition.

In some embodiments, NCCs and/or NCC particles may be incorporated into a spacer fluid, which is pumped between the mud and cement slurry to prevent contamination. NCCs and/or NCC particles may be added to increase and/or maintain an effective viscosity to prevent the mud mixing with the cement. In some embodiments, the fluids, treatment fluids, or compositions of the present disclosure may comprise one or more NCCs and/or NCC particles for the above-mentioned use in an amount of from about 0.001 wt % to about 10 wt %, 0.01 wt % to 10 wt %, 0.1 wt % to 5 wt %, or of from about 0.5 wt % to about 5 wt % based on the total weight of the fluid, treatment fluid, or composition.

In another embodiment, NCCs and/or NCC particles may be used as an emulsion stabilizer to improve the stability of various emulsions employed in acidizing process, aqueous biphasic systems and/or foam stabilization. Surface modification of the NCCs and/or NCC particles (such as, for example, modifying the surface of the NCCs and/or NCC particles to include a hydrocarbon group) may be employed to enhance or attenuate one or more of the properties of the NCCs and/or NCC particles in conjunction with the above uses, as desired. The term “hydrocarbon group” refers, for example, to a hydrocarbon group that is either branched or unbranched, such as for example, a group having the general formula CₙH₂₊₁ or CₙH₂ₙ₋₁, in which n is an integer having a value of 1 or more. For example, n may be in the range from 1 to about 60, or 5 to 50. In some embodiments, the fluids, treatment fluids, or compositions of the present disclosure may comprise one or more NCCs and/or NCC particles for the above-mentioned uses in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

In another embodiment, NCCs and/or NCC particles may be used to increase the thermal stability of polymer fluids, such as those fluids that contain viscoelastic surfactant (VES). Surface modification of the NCCs and/or NCC particles (such as, for example, increasing or decreasing the charge density or the type of charge (anionic or cationic) on the surface of the NCCs and/or NCC particles) may be employed to enhance or attenuate one or more of the properties of the NCCs and/or NCC particles in conjunction with the above uses, as desired. In some embodiments, the fluids, treatment fluids, or compositions of the present disclosure may comprise one or more NCCs and/or NCC particles for the above-mentioned uses in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

In another embodiment, NCCs and/or NCC particles may be used to improve the transport and the suspension of various solid materials often included in the above well treatment fluids, to transport pill materials, proppant and gravel. Surface modification of the NCCs and/or NCC particles may be employed to enhance or attenuate one or more of the properties of the NCCs and/or NCC particles in conjunction with the above uses, as desired. In some embodiments, the fluids, treatment fluids, or compositions of the present disclosure may comprise one or more NCCs and/or NCC particles for the above-mentioned uses in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

In another embodiment, NCCs and/or NCC particles may be used to increase the salt tolerance of sea water and/or produced water. Surface modification of the NCCs and/or NCC particles (such as, for example, increasing or decreasing the charge density on the surface of the NCCs and/or NCC particles) may be employed to enhance or attenuate one or more of the properties of the NCCs and/or NCC particles in conjunction with the above uses, as desired. In some embodiments, the fluids, treatment fluids, or compositions of the present disclosure may comprise one or more NCCs and/or NCC particles for the above-mentioned uses in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

In another embodiment, NCCs and/or NCC particles may be used to increase the viscosity of aqueous fluids and non-aqueous based fluids (i.e., oil-based fluids). In some embodiments, the fluids, treatment fluids, or compositions of the present disclosure may comprise one or more NCCs and/or NCC particles for the above-mentioned uses in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The appropriate components and methods of patents may be selected for the present disclosure in embodiments thereof. Methods and fluids for fracturing an unconsolidated formation that includes injection of consolidating fluids, as disclosed in U.S. Pat. No. 6,732,800, the disclosure of which is herein incorporated by reference in its entirety. Techniques and fluids for the stimulation of very low permeability formations, as disclosed in U.S. Pat. No. 7,806,182, the disclosure of which is herein incorporated by reference in its entirety. Techniques and fluids for fluid-loss control in hydraulic fracturing operations and/or controlling lost circulation are known in the art, as disclosed in U.S. Pat. Nos. 7,482,311, 7,971,644, 7,956,016, and 8,381,813 the disclosures of which are herein incorporated by reference in their entireties. Fracturing fluids using degradable polymers as viscosifying agents, as disclosed in U.S. Pat. No. 7,858,561, the disclosure of which is herein incorporated by reference in its entirety. Conventional fracturing fluid breaking technologies and the design of fracturing treatments as described in U.S. Pat. No. 7,337,839, the disclosure of which is hereby incorporated by reference in its entirety. Techniques and fluids for gravel packing a wellbore penetrating a subterranean formation, as disclosed in U.S. Pat. No. 8,322,419, the disclosure of which is herein incorporated by reference in its entirety. Techniques and fluids for providing sand control within a well are known in the art, as disclosed in U.S. Pat. No. 6,752,206, the disclosure of which is herein incorporated by reference in its entirety. Techniques and compositions for drilling or cementing a wellbore are known in the art, as disclosed in U.S. Pat. No. 5,518,996, the disclosure of which is herein incorporated by reference in its entirety. Additionally, the following are some of the known methods of acidizing hydrocarbon bearing formations which can be used as part of the present method: U.S. Pat. Nos. 3,215,199; 3,297,090; 3,307,630; 2,863,832; 2,910,436; 3,251,415; 3,441,085; and 3,451,818, which are hereby incorporated by reference in their entirety.

Known methods, fluids, and compositions, such as those disclosed in the patents identified above, may be modified to incorporate an NCC and/or an NCC particle; or an NCC and/or an NCC particle may be used as a substitute for one or more components, such as, for example, a viscosifying agent, a proppant transport agent, a material strengthening agent, a fluid loss reducing agent, a friction reducer/drag reduction agent, a gas mitigation agent an additive for a cement composite, and/or as an additive to reinforce a wellbore and/or a cement column, disclosed in the patents identified above.

In embodiments, the NCCs and/or NCC particles added to such known fluids and/or compositions either in a pre-hydrated form in water, such as deionized water, or directly to such known fluids and/or compositions as a powder.

While the methods and treatment fluids of the present disclosure are described herein as comprising an NCC and/or an NCC particle, it should be understood that the methods and fluids of the present disclosure may optionally comprise other additional materials, such as the materials and additional components discussed in the aforementioned patents.

As discussed in more detail below, an NCC and/or an NCC particle may perform a variety of intended functions when present in a treatment fluid.

Fracturing Fluids Comprising NCCs and/or NCC Particles

The fluids and/or methods of the present disclosure may be used for hydraulically fracturing a subterranean formation. Techniques for hydraulically fracturing a subterranean formation are known to persons of ordinary skill in the art, and involve pumping a fracturing fluid into the borehole and out into the surrounding formation. The fluid pressure is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications,” Encyclopedia of Polymer Science and Engineering, vol. 10, pp. 328-366 (John Wiley & Sons, Inc. New York, N.Y., 1987) and references cited therein.

In some embodiments, hydraulic fracturing involves pumping a proppant-free viscous fluid, or pad—such as water with some fluid additives to generate high viscosity—into a well faster than the fluid can escape into the formation so that the pressure rises and the rock breaks, creating artificial fractures and/or enlarging existing fractures. Then, proppant particles are added to the fluid to form slurry that is pumped into the fracture to prevent it from closing when the pumping pressure is released. In the fracturing treatment, fluids of are used in the pad treatment, the proppant stage, or both.

In some embodiments, the fluids and/or methods of the present disclosure may be employed during a first stage of hydraulic fracturing, where a fluid is injected through wellbore into a subterranean formation at high rates and pressures. In such embodiments, the fracturing fluid injection rate exceeds the filtration rate into the formation producing increasing hydraulic pressure at the formation face. When the pressure exceeds a predetermined value, the formation strata or rock cracks and fractures. The formation fracture is more permeable than the formation porosity.

In some embodiments, the fluids and/or methods of the present disclosure may be employed during a later stage of hydraulic fracturing, such as where proppant is deposited in the fracture to prevent it from closing after injection stops. In embodiments, the proppant may be coated with a curable resin activated under downhole conditions. Different materials, such as bundles of fibers, or fibrous or deformable materials, may also be used in conjunction with NCCs and/or NCC particles to retain proppants in the fracture. NCCs and/or NCC particles and other materials, such as fibers, may form a three-dimensional network in the proppant, reinforcing it and limiting its flowback. At times, due to weather, humidity, contamination, or other environmental uncontrolled conditions, some of these materials can aggregate and/or agglomerate, making it difficult to control their accurate delivery to wellbores in well treatments.

Sand, gravel, glass beads, walnut shells, ceramic particles, sintered bauxites, mica and other materials may be used as a proppant. In embodiments, the NCCs and/or NCC particles of the present disclosure may be used, such as in a fluid mixture, to assist in the transport proppant materials. In some embodiments, the fluids, treatment fluids, or compositions of the present disclosure may comprise one or more NCCs and/or NCC particles for the above-mentioned proppant-related uses in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

In some embodiments, the hydraulic fracturing fluids may be aqueous solutions containing a thickener, such as a solvatable polysaccharide, a solvatable synthetic polymer, or a viscoelastic surfactant, that when dissolved in water or brine provides sufficient viscosity to transport the proppant. Suitable thickeners may include polymers, such as guar (phytogeneous polysaccharide), and guar derivatives (hydroxypropyl guar, carboxymethylhydroxypropyl guar). Other synthetic polymers such as polyacrylamide copolymers can be used also as thickeners. Water with guar represents a linear gel with a viscosity proportional to the polymer concentration. Cross-linking agents are used which provide engagement between polymer chains to form sufficiently strong couplings that increase the gel viscosity and create visco-elasticity. Common crosslinking agents for guar and its derivatives and synthetic polymers include boron, titanium, zirconium, and aluminum. Another class of non-polymeric viscosifiers includes the use of viscoelastic surfactants that form elongated micelles. Known hydraulic fracturing fluids, may be modified to incorporate an NCC and/or an NCC particle as a supplement to the thickener; or an NCC and/or an NCC particle may be used as a substitute for a conventional thickener, for example, a substitute for one or more of the above mentioned thickeners.

Further, disclosed herein are methods and fluids (such as well treatment fluids) for treating a subterranean formation that use NCCs and/or NCC particles as a delayed crosslinking agent which can be used to form complexes with the crosslinking metals in aqueous polymer-viscosified systems, and methods to increase the gel cross-linking temperature. For example, the NCCs and/or NCC particles of the present disclosure may be used as additive to the polymer fluid to potentially increase the viscosity of the formulation by forming an entangled network between the NCCs and/or NCC particles and the polymer in solution (by generation of an increase in initial viscosity prior to the addition of a metallic crosslinker, such as, for example, boron, titanium, zirconium, and aluminum).

In embodiments, proppant-retention agents, such as those that are commonly used during the latter stages of the hydraulic fracturing treatment to limit the flowback of proppant placed into the formation, used in the methods of the present disclosure may comprise NCCs and/or NCC particles (such as NCCs and/or NCC particles that may include a surface modifier) to assist in either the promotion or avoidance of aggregate or agglomerate formation. In some embodiments, the fluids, treatment fluids, or compositions of the present disclosure may comprise one or more NCCs and/or NCC particles as a proppant-retention agent in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition. In embodiments, such NCCs and/or NCC particles may include a surface modifier, such as a polymer that may or may not interact with the proppant or the coating on the proppant.

NCCs and/or NCC particles, such as those described herein, can also be used in fluid mixtures to assist in the transport of proppant and/or pill materials into the fractures. In some embodiments, the fluids, treatment fluids, or compositions of the present disclosure may comprise one or more NCCs and/or NCC to assist in the transport of proppant and/or pill materials in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The success of a hydraulic fracturing treatment depends upon hydraulic fracture conductivity and fracture length. Fracture conductivity is the product of proppant permeability and fracture width; units may be expressed as millidarcy-feet. Fracture conductivity is affected by a number of known parameters. Proppant particle size distribution is a parameter that influences fracture permeability. The concentration of proppant between the fracture faces is another (expressed in pounds of proppant per square foot of fracture surface) and influences the fracture width. One may consider high-strength proppants, fluids with excellent proppant transport characteristics (ability to minimize gravity-driven settling within the fracture itself), high-proppant concentrations, or proppants having a large diameter as means to improve fracture conductivity. Weak materials, poor proppant transport, and narrow fractures may lead to poor well productivity. Relatively inexpensive materials of little strength, such as sand, are used for hydraulic fracturing of formations with small internal stresses. Materials of greater cost, such as ceramics, bauxites and others, are used in formations with higher internal stresses. Chemical interaction between produced fluids and proppants may change the proppant's characteristics. One should also consider the proppant's long-term ability to resist crushing.

Additional details regarding the disclosure of hydraulic fracturing fluids are described in U.S. Pat. No. 8,061,424, the disclosure of which is incorporated by reference herein in its entirety.

As discussed above, disclosed herein are well treatment fluids prepared that comprise NCCs and/or NCC particles as a delayed crosslinking agent, which can be used to form complexes with the crosslinking metals in aqueous polymer-viscosified systems, and methods to increase the gel cross-linking temperature. The NCCs and/or NCC particles of the present disclosure may be used as additive in the polymer fluid to increase the viscosity of the formulation by forming an entangled network between the nanocellulose material and the polymer in solution (i.e., generation of an increase in initial viscosity prior to the addition of the metallic crosslinker described above).

It is well known that metal-crosslinked polymer fluids can be shear-sensitive after they are crosslinked. In particular, exposure to high shear may occur within the tubulars during pumping from the surface to reservoir depth, and can cause an undesired loss of fluid viscosity and resulting problems such as screenout. As used herein, the term “high shear” refers to a shear rate of 500/second or more. The high-shear viscosity loss in metal-crosslinked polymer fluids that can occur during transit down the wellbore to the formation is generally irreversible and cannot be recovered.

High volumes of formation fracturing and other well treatment fluids are commonly thickened with polymers such as guar gum, the viscosity of which is greatly enhanced by crosslinking with a metal such as chromium aluminum, hafnium, antimony, etc., more commonly a Group 4 metal such as zirconium or titanium. In reference to Periodic Table “Groups,” the new IUPAC numbering scheme for the Periodic Table Groups is used as found in HAWLEY'S CONDENSED CHEMICAL DICTIONARY, p. 888 (11th ed. 1987). See U.S. Pat. Nos. 7,678,050 and 7,678,745, the disclosures of which are incorporated by reference herein in their entirety.

It is well known that metal-crosslinked polymer fluids can be shear-sensitive after they are crosslinked. In particular, exposure to high shear may occur within the tubulars during pumping from the surface to reservoir depth, and can cause an undesired loss of fluid viscosity and resulting problems such as screenout. As used herein, the term “high shear” refers to a shear rate of 500/second or more. The high-shear viscosity loss in metal-crosslinked polymer fluids that can occur during transit down the wellbore to the formation is generally irreversible and cannot be recovered.

High shear sensitivity of the metal crosslinked fluids can sometimes be addressed by delaying the crosslinking of the fluid so that it is retarded during the high-shear conditions and onset does not occur until the fluid has exited the tubulars. Because the treatment fluid is initially cooler than the formation and may be heated to the formation temperature after exiting the tubulars, some delaying agents work by increasing the temperature at which gelation takes place. Bicarbonate and lactate are examples of delaying agents that are known to increase the gelling temperatures of the metal crosslinked polymer fluids. Although these common delaying agents make fluids less sensitive to high shear treatments, they may at the same time result in a decrease in the ultimate fluid viscosity. Also, the common delaying agents may not adequately increase the gelation temperature for the desired delay, especially where the surface fluid mixing temperature is relatively high or the fluid is heated too rapidly during injection.

In some conventional treatment systems, borate crosslinkers have been used in conjunction with metal crosslinkers, for example, in U.S. Pat. No. 4,780,223. In theory, the borate crosslinker can gel the polymer fluid at a low temperature through a reversible crosslinking mechanism that can be broken by exposure to high shear, but can repair or heal after the high shear condition is removed. The shear-healing borate crosslinker can then be used to thicken the fluid during high shear such as injection through the wellbore while the irreversible metal crosslinking is delayed until the high shear condition is passed. A high pH, for example a pH of 9 to 12 or more, may be used to effect borate crosslinking, and in some instances as a means to control the borate crosslinking. For example, the pH and/or the borate concentration may be adjusted on the fly in response to pressure friction readings during the injection so that the borate crosslinking occurs near the exit from the tubulars in the wellbore. Suitable metal crosslinkers are stable at these high pH conditions and do not excessively interfere with the borate crosslinking.

Additional details regarding delayed crosslinking agents are described in U.S. Patent Application Pub. No. 2008/0280790, the disclosure of which is incorporated by reference herein in its entirety.

Some aspects of the present disclosure are directed to methods of treating subterranean formations using an aqueous comprising NCCs and/or NCC particles and a mixture of a polymer that is crosslinked with a metal-ligand complex. The hydratable polymer is generally stable in the presence of dissolved salts. Accordingly, ordinary tap water, produced water, brines, and the like can be used to prepare the NCCs and/or NCC particles and polymer solution used in an embodiment of the aqueous mixture.

In embodiments where the aqueous medium is a brine, the brine is water comprising an inorganic salt or organic salt. Some useful inorganic salts include, but are not limited to, alkali metal halides, such as potassium chloride. The carrier brine phase may also comprise an organic salt, such as sodium or potassium formate. Some inorganic divalent salts include calcium halides, such as calcium chloride or calcium bromide. Sodium bromide, potassium bromide, or cesium bromide may also be used. The salt is chosen for compatibility reasons i.e. where the reservoir drilling fluid used a particular brine phase and the completion/clean up fluid brine phase is chosen to have the same brine phase. Some salts can also function as stabilizers, for example, clay stabilizers such as KCl or tetramethyl ammonium chloride (TMAC), and/or charge screening of ionic polymers.

NCCs and/or NCC particles may also be used to enhance the salt tolerance of the polymer systems. For example, with the addition of NCCs and/or NCC particles, the polymer fluids may be able easily withstand 10 wt. % salts, such as KCl, KBr, NaCl, NaBr, or the like, which could make these polymer fluids more advantageous for sea water or produced water applications. In some embodiments, the fluids, treatment fluids, or compositions of the present disclosure may comprise one or more NCCs and/or NCC particles to enhance the salt tolerance of the polymer systems in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The hydratable polymer in an embodiment is a high molecular weight water-soluble polysaccharide containing cis-hydroxyl and/or carboxylate groups that can form a complex with the released metal and optionally the NCCs and/or NCC particles. Without limitation, useful polysaccharides have molecular weights in the range of about 200,000 to about 3,000,000. Galactomannans represent an embodiment of polysaccharides having adjacent cis-hydroxyl groups for the purposes herein. The term galactomannans refers in various aspects to natural occurring polysaccharides derived from various endosperms of seeds. They are primarily composed of D-mannose and D-galactose units. They generally have similar physical properties, such as being soluble in water to form thick highly viscous solutions which may be gelled (crosslinked) by the addition of such inorganic salts as borax. Examples of some plants producing seeds containing galactomannan gums include tara, huisache, locust bean, palo verde, flame tree, guar bean plant, honey locust, lucerne, Kentucky coffee bean, Japanese pagoda tree, indigo, jenna, rattlehox, clover, fenergruk seeds, soy bean hulls and the like. The gum is provided in a convenient particulate form. Of these polysaccharides, guar and its derivatives are suitable examples. These include guar gum, carboxymethyl guar, hydroxyethyl guar, carboxymethylhydroxyethyl guar, hydroxypropyl guar (HPG), carboxymethylhydroxypropyl guar (CMHPG), guar hydroxyalkyltriammonium chloride, and combinations thereof. As a galactomannan, guar gum is a branched copolymer containing a mannose backbone with galactose branches.

Heteropolysaccharides, such as diutan, xanthan, diutan mixture with any other polymers, and scleroglucan may be used as the hydratable polymer. Synthetic polymers such as, but not limited to, polyacrylamide and polyacrylate polymers and copolymers may be used for high-temperature applications. Examples of suitable viscoelastic surfactants useful for viscosifying some fluids include cationic surfactants, anionic surfactants, zwitterionic surfactants, amphoteric surfactants, nonionic surfactants, and combinations thereof.

The hydratable polymer may be present at any suitable concentration. In various embodiments hereof, the hydratable polymer can be present in an amount of from about 1.2 to less than about 7.2 g/L (10 to 60 pounds per thousand gallons or ppt) of liquid phase, or from about 15 to less than about 40 pounds per thousand gallons, from about 1.8 g/L (15 ppt) to about 4.2 g/L (35 ppt), 1.8 g/L (15 ppt) to about 3 g/L (25 ppt), or even from about 2 g/L (17 ppt) to about 2.6 g/L (22 ppt). Generally, the hydratable polymer can be present in an amount of from about 1.2 g/L (10 ppt) to less than about 6 g/L (50 ppt) of liquid phase, with a lower limit of polymer being no less than about 1.2, 1.32, 1.44, 1.56, 1.68, 1.8, 1.92, 2.04, 2.16 or 2.18 g/L (10, 11, 12, 13, 14, 15, 16, 17, 18, or 19 ppt) of the liquid phase, and the upper limit being less than about 7.2 g/L (60 ppt), no greater than 7.07, 6.47, 5.87, 5.27, 4.67, 4.07, 3.6, 3.47, 3.36, 3.24, 3.12, 3, 2.88, 2.76, 2.64, 2.52, or 2.4 g/L (59, 54, 49, 44, 39, 34, 30, 29, 28, 27, 26, 25, 24, 23, 22, 21, or 20 ppt) of the liquid phase. In some embodiments, the polymers can be present in an amount of about 2.4 g/L (20 ppt).

Fluids incorporating a hydratable polymer and NCCs and/or NCC particles may have any suitable viscosity, such as a viscosity value of about 50 mPa-s or greater at a shear rate of about 100 s⁻¹ at treatment temperature, or about 75 mPa-s or greater at a shear rate of about 100 s⁻¹ at the treatment temperature, or about 100 mPa-s or greater at a shear rate of about 100 s⁻¹ at the treatment temperature, in some instances. At the concentrations mentioned, the hydration rate is independent of guar concentration. Use of lower levels tends to lead to development of insufficient viscosity, while higher concentrations tend to waste material. Where those disadvantages are avoided, higher and lower concentrations are useful.

When a polymer is referred to as comprising a monomer or comonomer, the monomer is present in the polymer in the polymerized form of the monomer or in the derivative from the monomer. However, for ease of reference the phrase comprising the (respective) monomer or the like may be used as shorthand.

When crosslinkers are used in wellbore treatment fluids for subterranean applications, in one embodiment, one or more NCCs and/or NCC particles and optionally a water soluble polymer may be placed into and hydrated in a mixer with water, which can contain other ingredients such as surfactants, salts, buffers, and temperature stabilizers. A concentrated crosslinker solution, comprising from 1000 ppm of the metal-ligand complex up to saturation, is added prior to the fluid mixture being pumped into the well to provide the desired concentration of the metal in the injected fluid mixture. Applications such as hydraulic fracturing, gravel packing and conformance control use such crosslinked fluid systems. The liquid crosslinker additive concentrations may range from about 0.01 volume percent to 1.0 percent by volume, such as, for example, from about 0.1 volume percent to 1.0 volume percent, based upon total volume of the liquid phase.

A buffering agent may be employed to buffer the fracturing fluid, i.e., moderate amounts of either a strong base or acid may be added without causing any large change in pH value of the fracturing fluid. In various embodiments, the buffering agent is a combination of: a weak acid and a salt of the weak acid; an acid salt with a normal salt; or two acid salts. Examples of suitable buffering agents are: NaH₂PO₄—Na₂HPO₄; sodium carbonate-sodium bicarbonate; sodium bicarbonate; and the like. By employing a buffering agent in addition to a hydroxyl ion producing material, a fracturing fluid is provided which is more stable to a wide range of pH values found in local water supplies and to the influence of acidic materials located in formations and the like. In some embodiments, the pH control agent is varied between about 0.6 percent and about 40 percent by weight of the polysaccharide employed.

Non-limiting examples of hydroxyl ion producing material include any soluble or partially soluble hydroxide or carbonate that provides the desirable pH value in the fracturing fluid to promote borate ion formation and crosslinking with the polysaccharide and polyol. The alkali metal hydroxides, for example, sodium hydroxide, and carbonates. Other acceptable materials are calcium hydroxide, magnesium hydroxide, bismuth hydroxide, lead hydroxide, nickel hydroxide, barium hydroxide, strontium hydroxide, and the like. At temperatures above about 79° C. (175° F.), potassium fluoride (KF) can be used to prevent the precipitation of MgO (magnesium oxide) when magnesium hydroxide is used as a hydroxyl ion releasing agent. The amount of the hydroxyl ion releasing agent used in an embodiment is sufficient to yield a pH value in the fracturing fluid of at least about 8.0, such as at least 8.5, or at least about 9.5, or between about 9.5 and about 12.

Aqueous fluid embodiments may also comprise an organoamino compound to adjust the pH. Examples of suitable organoamino compounds include, for example, tetraethylenepentamine (TEPA), triethylenetetramine, pentaethylenhexamine, triethanolamine (TEA), and the like, or any mixtures thereof. A particularly useful organoamino compound is TEPA. When organoamino compounds are used in fluids, they are incorporated at an amount from about 0.01 weight percent to about 2.0 weight percent based on total liquid phase weight. When used, the organoamino compound is incorporated at an amount from about 0.05 weight percent to about 1.0 weight percent based on total liquid phase weight.

A borate source can be used as a co-crosslinker, especially where low temperature, reversible crosslinking is used in the method for generally continuous viscosification before the polymer is crosslinked with the metal-ligand complex, or simultaneously. In embodiments, the aqueous mixture, such as an aqueous mixture comprising one or more NCCs and/or NCC particles, can thus include a borate source (also referred to as a borate slurry), which can either be included as a soluble borate or borate precursor such as boric acid, or it can be provided as a slurry of borate source solids for delayed borate crosslinking until the fluid is near exit from the tubular into the downhole formation. By definition, “slurry” is a mixture of suspended solids and liquids. For example, a borate slurry component can include crosslinking delay agents such as a polyol compound, including NCCs, NCC particles, sorbitol, mannitol, sodium gluconate and combinations thereof. The borate slurry that is used in at least some embodiments can be prepared at or near the site of the well bore or can be prepared at a remote location and shipped to the well site. Methods of preparing slurries are known in the art. In embodiments, the slurry may be prepared offsite, since this can reduce the expense associated with the transport of equipment and materials.

Solid borate crosslinking agents suitable in certain embodiments are water-reactive and insoluble in a non-aqueous slurry, but become soluble when the slurry is mixed with the aqueous medium. The term “non-aqueous”, as used herein, in one sense refers to a composition to which no water has been added as such, and in another sense refers to a composition the liquid phase of which comprises no more than about 1, 0.5, 0.1 or about 0.01 weight percent water based on the weight of the liquid phase. The liquid phase of the borate slurry in embodiments can be a hydrocarbon or oil such as naphtha, kerosene or diesel, or a non-oily liquid. In the case of hydrophobic liquids such as hydrocarbons, the solubilization of the borate solids is delayed because it takes time for the water to penetrate the hydrophobic coating on the solids.

In certain embodiments, the solids will include a slowly soluble boron-containing mineral. These may include borates, such as anhydrous borax and borate hydrate, for example, sodium tetraborate.

In one embodiment, the liquid phase of the borate slurry can include a hygroscopic liquid which is generally non-aqueous and non-oily. The liquid can have strong affinity for water to keep the water away from any crosslinking agent, which would otherwise reduce the desired delay of crosslinking, i.e., accelerate the gelation. Glycols, including glycol-ethers, and especially including glycol-partial-ethers, represent one class of hygroscopic liquids. Specific representative examples of ethylene and propylene glycols include ethylene glycol, diethylene glycol, triethylene glycol, propylene glycol, dipropylene glycol, tripropylene glycol, C₁ to C₈ monoalkyl ethers thereof, and the like. Additional examples include 1,3-propanediol, 1,4-butanediol, 1,4-butenediol, thiodiglycol, 2-methyl-1,3-propanediol, pentane-1,2-diol, pentane-1,3-diol, pentane-1,4-diol, pentane-1,5-diol, pentane-2,3-diol, pentane-2,4-diol, hexane-1,2-diol, heptane-1,2-diol, 2-methylpentane-2,4-diol, 2-ethylhexane-1,3-diol, C₁ to C₈ monoalkyl ethers thereof, and the like.

In some embodiments, the hygroscopic liquid can include glycol ethers with the molecular formula R—OCH₂CHR¹OH, where R is substituted or unsubstituted hydrocarbyl of about 1 to 8 carbon atoms and R¹ is hydrogen or alkyl of about 1 to 3 carbon atoms. Specific representative examples include solvents based on alkyl ethers of ethylene and propylene glycol, commercially available under the trade designation CELLOSOLVE, DOWANOL, and the like. Note that it is conventional in the industry to refer to and use such alkoxyethanols as solvents, but herein the slurried borate solids should not be soluble in the liquid(s) used in the borate slurry.

The liquid phase of the borate slurry can have a low viscosity that facilitates mixing and pumping, for example, less than 50 cP (50 mPa-s), less than 35 cP (35 mPa-s), or less than 10 cP (10 mPa-s) in different embodiments. The slurry liquid can in one embodiment contain a sufficient proportion of the glycol to maintain hygroscopic characteristics depending on the humidity and temperature of the ambient air to which it may be exposed, i.e. the hygroscopic liquid can contain glycol in a proportion at or exceeding the relative humectant value thereof. As used herein, the relative humectant value is the equilibrium concentration in percent by weight of the glycol in aqueous solution in contact with air at ambient temperature and humidity, for example, 97.2 weight percent propylene glycol for air at 48.9° C. (120° F.) and 10% relative humidity, or 40 weight percent propylene glycol for air at 4.4° C. (40° F.) and 90% relative humidity. In other embodiments, the hygroscopic liquid can comprise at least 50 percent by weight in the slurry liquid phase (excluding any insoluble or suspended solids) of the glycol, at least 80 percent by weight, at least 90 percent by weight, at least 95 percent by weight, or at least 98 percent by weight.

If desired, in some embodiments, the borate slurry can also include a suspension aid to help distance the suspended solids from each other, thereby inhibiting the solids from clumping and falling out of the suspension. The suspension aid can include silica, organophilic clay, polymeric suspending agents, other thixotropic agents or a combination thereof. In certain embodiments the suspension aid can include polyacrylic acid, an ether cellulosic derivative (such cellulosic derivatives are polymers (such as for example, guar) and thus when solubilized in water, these molecules may separate into individual molecules; in contrast, NCC can be made to be dispersible in water, but are not soluble in water), polyvinyl alcohol, carboxymethylmethylcellulose, polyvinyl acetate, thiourea crystals or a combination thereof. As a crosslinked acrylic acid based polymer that can be used as a suspension aid, there may be mentioned the liquid or powdered polymers available commercially under the trade designation CARBOPOL. As an ether cellulosic derivative, there may be mentioned hydroxypropyl cellulose. Suitable organophilic clays include kaolinite, halloysite, vermiculite, chlorite, attapullgite, smectite, montmorillonite, bentonite, hectorite or a combination thereof.

The crosslink delay agent can provide performance improvement in the system through increased crosslink delay, enhanced gel strength when the polymer is less than fully hydrated, and enhanced rate of shear recovery. The polyol may be present in an amount effective for improved shear recovery. In some embodiments, the polyol may be present in an amount that is not effective as a breaker or breaker aid.

In embodiments, ionic polymers (such as CMHPG) in an aqueous solution can be present in solvated coils that have a larger radius of gyration than the corresponding non-ionic parent polymer due to electric repulsions between like charges from the ionic substituents. This may cause the polymer to spread out without sufficient overlapping of the functional groups from different polymer chains for a crosslinker to react with more than one functional group (no crosslinking), or it may cause the orientation of functional groups to exist in an orientation that is difficult for the crosslinker to reach. For example, in deionized water, guar polymer can be crosslinked easily by boron crosslinker while CMHPG cannot. Screening the charges of the ionic species can reduce the electric repulsion and thus collapse the polymer coil to create some overlapping, which in turn can allow the crosslinker to crosslink the ionic polymers.

Different compounds to screen the charges of an ionic polymer (for example CMHPG), namely KCl (or other salt to increase ionic strength) to screen, or ionic surfactants to screen, such as quaternary ammonium salt for CMHPG, may be used. Salts can be selected from a group of different common salts including organic or inorganic such as KCl, NaCl, NaBr, CaCl₂, R₄N⁺Cl⁻ (for example TMAC), NaOAc etc. Surfactants can be fatty acid quaternary amine chloride (bromide, iodide), with at least one alkyl group being long chain fatty acid or alpha olefin derivatives, other substituents can be methyl, ethyl, iso-propyl type of alkyls, ethoxylated alkyl, aromatic alkyls etc. Some methods may also use cationic polymers. The NCCs and/or NCC particles described herein may be used as an environmentally compatible ionic polymer charge screening compounds for the purpose of enhanced crosslinking ability and improved viscosity yield. For this purpose the NCCs and/or NCC particles may be functionalized with ionic charges, as discussed above.

Some fluids according to some embodiments may also include a surfactant. In some embodiments, for example, the aqueous mixture comprises both a stabilizer such as KCl or TMAC, as well as a charge screening surfactant. This system can be particularly effective in ligand-metal crosslinker methods that also employ borate as a low temperature co-crosslinker. Additionally, any surfactant which aids the dispersion and/or stabilization of a gas component in the base fluid to form an energized fluid can be used. Viscoelastic surfactants, such as those described in U.S. Pat. Nos. 6,703,352, 6,239,183, 6,506,710, 7,303,018 and 6,482,866, the disclosures of which are incorporated herein by reference in their entireties, are also suitable for use in fluids in some embodiments. Examples of suitable surfactants also include amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a suitable surfactant is the amphoteric alkyl amine contained in the surfactant solution AQUAT 944 (available from Baker Petrolite of Sugar Land, Tex.).

Charge screening surfactants may be employed, as previously mentioned. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants may have a negatively charged moiety and a hydrophobic or aliphatic tail, and can be used to charge screen cationic polymers. Examples of suitable ionic surfactants also include cationic surfactants, such as alkyl amines, alkyl diamines, alkyl ether amines, alkyl quaternary ammonium, dialkyl quaternary ammonium and ester quaternary ammonium compounds. Cationic surfactants may have a positively charged moiety and a hydrophobic or aliphatic tail, and can be used to charge screen anionic polymers such as CMHPG.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids. The fluids may incorporate the surfactant or blend of surfactants in an amount of about 0.02 weight percent to about 5 weight percent of total liquid phase weight, or from about 0.05 weight percent to about 2 weight percent of total liquid phase weight. A further suitable surfactant is sodium tridecyl ether sulfate.

The NCCs and/or NCC particles may be present in any of the fluids or compositions described herein in an amount of from about 5 wt % to about 70 wt %, of from about 10 wt % to about 60 wt %, of from about 20 wt % to about 50 wt %, from about 30 wt % to about 40 wt % based on the total weight of the fluid, treatment fluid, or composition. In some embodiments, the NCCs and/or NCC particles may be present in any of the fluids or compositions described herein in an amount of from about 0.001 wt % to about 10 wt %, such as, 0.01 wt % to 10 wt %, 0.1 wt % to 5 wt %, or of from about 0.5 wt % to about 5 wt %.

Fluid Loss

As discussed above, hydrocarbons (oil, condensate, and gas) may be produced from wells that are drilled into the formations containing them. The oil or gas residing in a subterranean formation can be recovered by drilling a well into the formation. A wellbore may be drilled down to the subterranean formation while circulating a drilling fluid through the wellbore. After the drilling is terminated, a string of pipe, such as a casing, is run into the wellbore. Then, the subterranean formation may be isolated from other formations using a technique known as well cementing. In particular and for a variety of reasons, such as inherently low permeability of the reservoirs or damage to the formation caused by drilling and completion of the well, the flow of hydrocarbons into the well is undesirably low. In this case, the well is “stimulated” for example using hydraulic fracturing, chemical (such as an acid) stimulation, or a combination of the two (called acid fracturing or fracture acidizing).

Nanocellulose may also be used as an environmentally compatible particle suspending agent and a fluid loss reducer in conjunction with various particles. In embodiments, a fluid loss reducing agent or particle suspending agent comprised of nanocellulose may enhance the fluid loss reducing agent's particle suspension ability. The fluid loss reducing agent and/or the particle suspending agent may be used in various subterranean treatment processes, such as, for example, fracturing, gravel packing, cementing, drilling fluid and any other fluid used for subterranean treatment. Further, examples of the particles that are capable of being suspended include the particles that various carbonates, such as calcium carbonate and magnesium carbonate, barite, clays, weighting agents, cement, proppant.

Hydraulic fracturing of oil or gas wells is a technique routinely used to improve or stimulate the recovery of hydrocarbons. In such wells, hydraulic fracturing may be accomplished by introducing a proppant-laden treatment fluid into a producing interval at high pressures and at high rates sufficient to crack the rock open. This fluid induces a fracture in the reservoir as it leaks off in the surrounding formation and transports proppant into the fracture. After the treatment, proppant remains in the fracture in the form of a permeable and porous proppant pack that serves to maintain the fracture open as hydrocarbons are produced. In this way, the proppant pack forms a highly conductive pathway for hydrocarbons and/or other formation fluids to flow into the wellbore.

Viscous fluids or foams may be employed as fracturing fluids in order to provide a medium that will have sufficient viscosity to crack the rock open, adequately suspend and transport solid proppant materials, as well as decrease loss of fracture fluid to the formation during treatment (commonly referred to as “fluid loss”). While a reduced fluid loss allows for a better efficiency of the treatment, a higher fluid loss corresponds to fluids “wasted” in the reservoir, and implies a more expensive treatment. Also, it is known that the degree of fluid loss can depend upon formation permeability. Furthermore fluid efficiency of a fracture fluid may affect fracture geometry, since the viscosity of the fluid might change as the fluid is lost in the formation. This is the case for polymer-based fracturing fluids that concentrate in lower permeability formations as the fracture propagates due to leak off of the water in the formation, while the polymer molecules remain in the fracture by simple size exclusion from the pores of the reservoir. The fluid in the fracture increases in viscosity as the fracture propagates and the fracture generated will also increase in width as well as in length. In the case of viscoelastic surfactant (VES) based fluids, the fracturing fluid does not concentrate since the fracturing fluid is lost in the formation and the fractures generated may be long and very narrow. Hence, fluid efficiency affects fracture geometry.

For VES based fluids, excessive fluid loss results in fractures that are narrower than desired. Also, excessive fluid loss may translate into a bigger job size where hundreds of thousands of additional gallons of water may be pumped to generate a suitable length of fracture and overcome low fluid efficiency. Fracturing fluids should have a minimal leak-off rate to avoid fluid migration into the formation rocks and minimize the damage that the fracturing fluid or the water leaking off does to the formation. Also the fluid loss should be minimized such that the fracturing fluid remains in the fracture and can be more easily degraded, so as not to leave residual material that may prevent hydrocarbons to flow into the wellbore.

In order to attain a sufficient fluid viscosity and thermal stability in high temperature reservoirs, linear polymer gels were partially replaced by cross-linked polymer gels such as those based on guar crosslinked with borate or polymers crosslinked with metallic ions. However, as it became apparent that crosslinked polymer gel residues might not degrade completely and leave a proppant pack with an impaired retained conductivity, fluids with lower polymer content were introduced. In addition, some additives were introduced to improve the cleanup of polymer-based fracturing fluids. These included polymer breakers. Nonetheless the polymer based fracturing treatments leave proppant pack with damaged retained conductivity since the polymer fluids concentrate in the fracture while the water leaks off in the reservoir that may impair the production of hydrocarbons from the reservoir.

Based on reservoir simulations and field data, it is commonly observed that production resulting from a fracturing treatment is often lower than expected. This phenomenon is particularly the case in tight gas formations. Indeed, production can be decreased by concentrated polymer left in the fracture due to leak off of the fracturing fluid during treatment. Filter cakes may result in poor proppant pack cleanup due to the yield stress properties of the fluid. This may happen when a crosslinked polymer based fluid is pumped that leaks off into the matrix and becomes concentrated, and extremely difficult to remove. Breaker effectiveness may thus become reduced, and viscous fingering inside the proppant pack may occur which further results in poor cleanup. Furthermore, the filter cake yield stress created by the leak off process can occlude the fracture width and restrict fluid flow, resulting in a reduction in the effective fracture half-length.

In embodiments, the methods of the present disclosure for treating subterranean formations may use fluids, such as fluids that comprise NCCs and/or NCC particles, that enable efficient pumping, and decrease (and control) the leak off relative to conventional fracturing treatments in order to reduce the damage to the production, while having good cleanup properties as well as improved fluid efficiency. Depending on the size of the NCCs and/or NCC particles and pore throat of the formation, NCCs and/or NCC particles may be used to bridge the pores of the formation (such as nanoporous reservoirs, for example, shales) at the surface face, thus leading to a filter-cake that will reduce fluid loss.

In embodiments, the fluids, treatment fluids, or compositions of the present disclosure may contain a fluid loss reducer comprising NCCs and/or NCC particles, the NCCs and/or NCC particles being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain a fluid loss reducer comprising NCCs and/or NCC particles, the NCCs and/or NCC particles being present in an amount of from about 0.01 wt % to 10 wt %, such as 0.1 wt % to 5 wt %, or of from about 0.5 wt % to about 5 wt % based on the total weight of the fluid, treatment fluid, or composition.

Friction Reducer/Drag Reduction

The NCCs and/or NCC particles may also be incorporated into a well treatment fluid that is located within the wellbore to assist in reducing the surface treating pressure (i.e., friction) or drag reduction, which also reduces the fatigue accumulation of the pumping device. For example, the NCCs and/or NCC particles may act as friction reducers with the alignment of the rod-like particles along the flow, thereby minimizing friction drag and pressure loss.

Occasionally, hydraulic fracturing is done without a highly viscosified fluid (i.e., slick water) to minimize the damage caused by polymers or the cost of other viscosifiers. These slick water treatments are often carried out by injecting into the fluid stream very small concentrations of a compound or mixture of compounds aimed to reduce the friction in the well with minimal or negligible viscosification, and therefore minimize the horsepower used on location to execute the fracturing operation. Often high molecular weight polymers are used as friction reducers. Even if the concentration of friction reducer is generally low, the high molecular weight polymers used as friction reducers can concentrate in the proppant pack or in the fracture face, what is believed to impair the production from certain formations such as low permeability gas bearing sandstone reservoirs or gas bearing shale reservoirs. Therefore, the development of non-damaging friction reducers is desirable. Breakers such as oxidizers or enzymes may not be very effective at breaking the chains of the conventional friction reducers.

Wells tend to produce sand and fines from the formation. In order to prevent damage to the surface equipment, and ensure high productivity, gravel packing treatments are carried out. In gravel packing, sand or gravel is placed into the space between a well (open formation or casing) and a screen. Fluids used to carry the sand are normally viscous fluids. In some particular applications sand or gravel is transported at high rates without a viscous carrying fluid (water packs). These water packs might be carried out by injecting into the fluid stream small concentrations of a compound or mixture of compounds aimed to reduce the friction in the well with minimal or negligible viscosification, and therefore minimize the horsepower used on location to execute the gravel packing operation, or extend the length of the well that can be treated for horizontal wells. Often high molecular weight polymers are used as friction reducers. Even if the concentration of friction reducer is generally low, the high molecular weight polymers used as friction reducers can concentrate in the gravel pack, what is believed to impair the production. Non-damaging friction reducers may also be used in gravel packing treatments.

One of more additional friction reducers may also be included with the well treatment fluid. Examples of additional friction reducer polymers include as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 may also be used. These polymeric species added as friction reducers or viscosity index can further function as fluid loss additives reducing the use of conventional fluid loss additives. Latex resins or polymer emulsions may be incorporated as fluid loss additives. Shear recovery agents may also be used in embodiments.

In embodiments, the fluids, treatment fluids, or compositions of the present disclosure may contain a friction reducer/drag reduction agent comprising NCCs and/or NCC particles, the NCCs and/or NCC particles being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain a friction reducer/drag reduction agent comprising NCCs and/or NCC particles, the NCCs and/or NCC particles being present in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

Gas Migrationcontrol

NCCs and/or NCC particles may also be used as an additive (or by itself) for conventional gas migration control agents, such as lattices, to improve their effectiveness. More specifically, NCCs and/or NCC particles may be used to produce a composition having excellent gas barrier properties, for example, for gases including oxygen, air, and gaseous hydrocarbons. For example, when placed within a matrix, the NCCs and/or NCC particles may modify the flow path of gas, depending on the concentration, crystallinity and arrangement of the NCC within the matrix. In embodiments, the NCCs and/or NCC particles may be incorporated into a polymer and/or a film such as a PLA film, for improved the oxygen barrier properties.

In embodiments, the fluids, treatment fluids, or compositions of the present disclosure may contain a gas migration control agent comprising NCCs and/or NCC particles, the NCCs and/or NCC particles being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain a gas migration control agent comprising NCCs and/or NCC particles, the NCCs and/or NCC particles being present in an amount of from about 0.01 wt % to 10 wt %, such as 0.1 wt % to 5 wt %, or of from about 0.5 wt % to about 5 wt % based on the total weight of the mix water

Cementing

The NCCs and/or NCC particles may also be used as an additive in a cementing composition. Generally cementing a well includes pumping a cement slurry from the surface down the casing so that it then returns towards the surface via the annulus between the casing and the borehole. One of the purposes of cementing a well is to isolate the different formation layers traversed by the well to prevent fluid migration between the different geological layers or between the layers and the surface. For safety reasons, prevention of any gas rising through the annulus between the borehole wall and the casing is desirable.

When the cement has set, it is impermeable to gas. Because of the hydraulic pressure of the height of the cement column, the injected slurry is also capable of preventing such migration. However, there is a phase, between these two states which lasts several hours during which the cement slurry no longer behaves as a liquid but also does not yet behave as an impermeable solid. For this reason, additives, such as those described in U.S. Pat. Nos. 4,537,918, 6,235,809 and 8,020,618, the disclosures of which are incorporated by reference herein their entirety, may be added to maintain a gas-tight seal during the whole cement setting period.

The concept of fluid loss (discussed above in greater detail) is also observed in cement slurries. Fluid loss occurs when the cement slurry comes into contact with a highly porous or fissured formation. Fluid from the cement slurry will migrate into the formation altering the properties of the slurry. When fluid loss occurs it makes the cement hardens faster than it supposed to, which could lead to incomplete placement. Fluid loss control additives, such as substituted glycine, may be used to prevent or at least limit the fluid loss that may be sustained by the cement slurry during placement and its setting.

In addition, in locations where the climate is cold, such as Russia, Alaska, and Canada for example, liquid additives are not appropriate. In cold climates the liquid additives are difficult to handle as they become hard and therefore are not as pourable, which can lead to difficulties in proper mixing in the cement slurry.

Foamed hydraulic cement slurries are commonly utilized in forming structures above and below ground. In forming the structures, the foamed hydraulic cement composition may be pumped into a form or other location to be cemented and allowed to set therein. Heretofore, foamed cement slurries have included foaming and stabilizing additives which include components such as isopropyl alcohol that interfere with aquatic life. In addition, one or more of the components are often flammable and make the shipment of the foaming and stabilizing additives expensive. The foamed hydraulic cement slurries of the present disclosure may include environmentally benign foaming and stabilizing additives, such as NCCs or NCC particles, which do not include flammable components.

NCCs and/or NCC particles have substantially more surface areas than the conventional micro fibers. Because of this, NCCs and/or NCC particles may possess the unique capability of stabilizing the interface between liquid and gas phases of a foamed cement slurry. For instance, the homogeneity and quality (“quality” defined as the percentage of foam in cement slurry) of nitrogen or air foamed cement slurries can be greatly improved. This may allow for the minimization in the amount of foaming agents. Additionally, when compared to the conventional foamed cement at the same density, the incorporation of NCCs and/or NCC particles may also improve the cement mechanical strength and lower cement permeability. The addition of NCCs and/or NCC particles may also enable foamed cement to reach higher foam quality and thus further lower set cement density, for instance, stable foamed slurries of higher than 50% quality, or higher than 75% quality can be easily prepared.

In the construction and repair of wells such as oil and gas wells, foamed hydraulic cement slurries are often pumped into locations in the wells to be cemented and allowed to set therein. In primary well cementing, foamed cement slurries are extensively used to cement off-shore deep water wells wherein they encounter temperatures varying between 40° F. and 50° F. The foamed cement slurries may then be pumped into the annular spaces between the walls of the well bores and the exterior surfaces of pipe strings disposed therein. The foamed cement slurries are compressible which prevents the inflow of undesirable fluids into the annular spaces and the foamed cement slurries set therein whereby annular sheaths of hardened cement are formed therein. The annular cement sheaths physically support and position the pipe strings in the well bores and bond the exterior surfaces of the pipe strings to the walls of the well bores whereby the undesirable migration of fluids between zones or formations penetrated by the well bores is prevented.

Foamed hydraulic cement slurries are commonly utilized in forming structures above and below ground. In forming the structures, the foamed hydraulic cement composition is pumped into a form or other location to be cemented and allowed to set therein. Heretofore, foamed cement slurries have included foaming and stabilizing additives which include components such as isopropyl alcohol that interfere with aquatic life. In addition, one or more of the components are often flammable and make the shipment of the foaming and stabilizing additives expensive. Thus, foamed hydraulic cement slurries which include environmentally benign foaming and stabilizing additives that do not include flammable components are desired.

A variety of hydraulic cements can be utilized in accordance with the present application including, for example, Portland cements, slag cements, silica cements, pozzolana cements and aluminous cements. Specific examples of Portland cements include Classes A, B, C, G and H.

The water in the foamed cement slurry can be fresh water, unsaturated salt solutions or saturated salt solutions. Generally, the water in the foamed cement slurry is present in an amount in the range of from about 35% to about 70%, from about 35% to about 65%, from about 40% to about 60%, and from about 45% to about 55%, by weight of the hydraulic cement therein.

The gas utilized to foam the cement slurry can be air or nitrogen. Generally, the gas may be present in the foamed cement slurry in an amount in the range of from about 10% to about 80%, from about 20% to about 70%, from about 30% to about 60%, from about 30% to about 50% and from about 40% to about 50% by volume of the slurry. Additional additives such as a surfactants and foaming additives may also be included.

In embodiments, the fluids, treatment fluids, or compositions of the present disclosure may contain a foaming and/or stabilizing additive comprising NCCs and/or NCC particles, the NCCs and/or NCC particles being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain a foaming and/or stabilizing additive comprising NCCs and/or NCC particles, the NCCs and/or NCC particles being present in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The NCCs and/or NCC particles may act as a binder or surface activating agent for various cement composites and potentially increase the affinity between the two different phases in the cement composites. Therefore, in addition to reinforcing set cement prepared based on conventional formulations, the presence of NCCs and/or NCC particles may allow components with sharply-contrasting properties to co-exist in the composite formulations. For instance, hydrophobic monomers like styrene can now be mixed with slurries and cured to form new types of cement composites.

NCCs and/or NCC particles may be used in cementing or fracturing any wells in which stable flexible cement is desired. The application likely directed to the application of NCCs and/or NCC particles in vertical wells, but is equally applicable to wells of any orientation.

Fibrous materials, such as anti-settling agents, are known to aid suspending particles in a fluid system. For instance, cylindrical fibers with diameters ranges between 20 to 100 microns are commonly used to suspend particles in the size range of 100 to 1,000 microns. However, most of the cement particles are less than tens of microns, therefore, much thinner fibers like NCCs and/or NCC particles may be used to suspend the smaller cement particles effectively. The addition of a suitable amount of NCCs and/or NCC particles to common Portland cement slurries may minimize free fluid formation but also minimizes the use of viscosifiers.

According to the present disclosure, the slurry cement composition for cementing a well comprises a hydraulic cement, water, NCCs and/or NCC particles and graphite. Graphite may be used as a coarse particulate graphite average diameter is around 70 to 500 μm for the particle size.

Portland cement containing carbon fiber and particulate graphite demonstrates reduced cement resistivity values, when compared to the resistivity values of conventional cement with no fibers or graphite present. Small concentrations of carbon fiber provide a connective path through the cement matrix for electrons to flow.

Other additives may be present in the blend, such as fillers, retarders, fluid loss prevention agents, dispersants, rheology modifiers and the like. In one embodiment, the blend also includes a polyvinyl alcohol fluid loss additive (0.1% to 1.6%) by weight of blend (“BWOB”), polysulfonate dispersant (0.5-1.5% BWOB), carbon black conductive filler aid not exceeding 1.0% BWOB, and various retarders (lignosulfonate, short-chain purified sugars with terminal carboxylate groups, and other proprietary synthetic retarder additives). In another embodiment, the blend also includes a polyvinyl chloride fluid loss additive (0.2-0.3% by weight of blend (“BWOB”), polysulfonate dispersant (0.5-1.5% BWOB), carbon black conductive filler aid not exceeding 1.0% BWOB, and various retarders (lignosulfonate, short-chain purified sugars with terminal carboxylate groups, and other proprietary synthetic retarder additives). In some formulations, silica or other weighting additives, such as hematite or barite, may be used to optimize rheological properties of the cement composite slurry during placement across the zone of interest. Suitable silica concentrations may not exceed 40% BWOC (by weight of cement). This is done to prevent strength retrogression when well temperatures may exceed 230.degree. F. For most formulations, hematite or barite does not exceed 25% BWOB or BWOC.

In embodiments, the compositions of the present disclosure may contain a binder or surface activating agent comprising NCCs and/or NCC particles, the NCCs and/or NCC particles being present in an amount of from about 5 wt % to about 70 wt %, of from about 10 wt % to about 60 wt %, of from about 20 wt % to about 50 wt %, or of from about 30 wt % to about 40 wt % based on the total weight of the composition. In some embodiments, compositions of the present disclosure may contain a binder or surface activating agent comprising NCCs and/or NCC particles, the NCCs and/or NCC particles being present in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

Fibrous materials are known to aid suspending particles in a fluid system. For instance, cylindrical fibers with diameters ranges between 20 to 100 microns are commonly used to suspend particles in the size range of 100 to 1,000 microns. However, most of the cement particles are less than tens of microns, therefore, much thinner fibers like NCCs and/or NCC particles may be used to suspend the cement particles having a particle size of about 1 μm to about 100 μm, such as from about 10 μm to about 75 μm, from about 10 μm to about 50 μm, and from about 25 μm to about 40 μm, effectively. Addition of suitable amount of NCCs and/or NCC particles to common Portland cement slurries minimizes free fluid formation and also minimizes the use of viscosifiers. The rheological behavior of cement slurries is more or less well described by the so-called Bingham's plastic model. According to said model, the shear stress versus shear rate dependence is a straight line of slope PV (for plastic viscosity) and of initial ordinate YV (for Yield value). A further property of the slurry resides in the value of plastic viscosity (PV) and the yield value (YV). To be easily pumpable, a cement slurry should present a plastic viscosity and a yield value as low as possible if a turbulent flow is desired.

To this effect, it is known to add, in conventional manner, chemical agents named “dispersants” or “plasticizers” to the mix water These agents help decrease the plastic viscosity and yield value of a neat cement slurry (of class G, for example) from 40 cP to 20 cP and from 45 to 0 lbs/100 ft², respectively.

A further property of suitable cement slurries resides in its capacity to remain homogeneous while left to stand, for the period between the end of pumping and for setting. Very often, a more or less clear supernatant known as “free water” forms atop of the slurry column which is due to bleeding or sedimentation of the cement particles; the part of the annulus opposite the supernatant will not be adequately cemented.

A reason for this phenomenon can be found in the fact that, beyond a given threshold of dispersant concentration, the cement particles are subjected to repulsive forces. This corresponds to a saturation of the particles surface by the adsorbed molecules of dispersant, the cement particles then acting as elementary entities adapted to sediment in a liquid medium.

If on the contrary, the concentration of dispersant does not correspond to saturation, attractive forces remain between the negative-charge areas of a cement particle which have been covered by the dispersant, and the non-covered positive-charge areas of another cement particle, resulting in the formation, inside the liquid phase, of a fragile tridimensional structure, which contributes to keeping the particles in suspension. The pressure which is applied to this structure to destroy it and to set the fluid flowing is the “yield value” (YV). A yield value YV higher than 0 will therefore indicate the presence of such a tridimensional structure in the slurry.

In embodiments, the fluids, treatment fluids, or compositions of the present disclosure may contain a fiber comprising NCCs and/or NCC particles, the NCCs and/or NCC particles being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain a fiber comprising NCCs and/or NCC particles, the NCCs and/or NCC particles being present in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

Due to its nano-size, NCCs and/or NCC particles may penetrate unconsolidated rock formation, thus can be used to consolidate and strengthen the wellbore. For instance, a settable pill containing NCCs and/or NCC particles penetrates high permeability formations and the presence of NCCs and/or NCC particles inside the rock may render the set pill stronger than the same pill without the NCCs and/or NCC particles. The conventional micro-cement formulation that is designed for remediation may also benefit from having NCCs and/or NCC particles. The NCCs and/or NCC particles may invade small cracks alone with the whole cement formulation, and lead to better set-cement mechanical properties to repair leaking.

The NCCs and/or NCC particles may also be used to repair small cracks in a cement sheath that occur because of various stresses. The NCCs and/or NCC particles may be incorporated into a “micro-cement” system or micro-cement formulation that may be employed to fill and repair the cracks and/or provide structural reinforcement. Similarly, the NCCs and/or NCC particles may be an agent that is incorporated into a fluid or formulation that may be employed to fill and repair the cracks and/or provide structural reinforcement for conventional composites.

In embodiments, the fluids (such as a micro-cement formulation), treatment fluids, or compositions of the present disclosure may contain an agent as described above, such as a remedial cementing agent or cement column remediation agent, comprising NCCs and/or NCC particles, the NCCs and/or NCC particles being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids (such as a micro-cement formulation), treatment fluids, or compositions of the present disclosure may contain an agent as described above, such as a remedial cementing agent or cement column remediation agent, comprising NCCs and/or NCC particles, the NCCs and/or NCC particles being present in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

Stabilizers

The addition of the NCCs and/or NCC particles may also improve the stability of an emulsion due to the formation of a network at the oil in water interface. More specifically, the high surface area of the NCC particle may allow for the NCC or NCC particle to rest at the interface in the oil-in-water emulsion. This property of the NCCs and/or NCC particles can be used in applications such as acidizing (for example SUPER-XEMULSION or “SXE” fluids) where the stabilization of oil in water is desired.

The stabilization of foam (supercritical CO₂ in water for instance) can be stabilized with NCCs and/or NCC particles as well.

Water emulsions may include comprising at least one polymer hydrolysable in the downhole environment, where the water emulsion is in the form of an organic phase dispersed in the water phase, and where the organic phase contains the polymer hydrolysable in the downhole environment, an organic solvent of the polymer (possibly, also hydrolysable in the downhole environment), an emulsifier, a viscosity controller and at least one stabilizer. One method of obtaining said water emulsion comprises slow dissolution of said solid hydrolysable polymer in said organic solvent at a temperature that may be above the polymer glass transition point, cooling of the solution at a temperature from about 20 to about 40° C., preparation of the treatment fluid in a separate blender with the addition of an efficient quantity of a surfactant, and the addition of the hydrolysable polymer solution to the treatment fluid with sufficiently intense stirring for the production of a stable emulsion. In some cases, the polymer dissolved in the organic solvent can be preliminarily hydrolyzed to the desired viscosity. As discussed above, NCC or NCC particles may be added as stabilizers to the emulsion fluid in addition to the materials described above. Emulsion stabilizers may be added to the treatment fluid, if desired.

In some instances, the hydrolysable polymer may be a lactic acid polymer, glycolic acid polymer, their copolymers and mixtures thereof. The polymer may be selected such that its hydrolysis in the downhole environment produces a sticky polymer material, and the downhole hydrolysis may be irreversible. The solvent for the class of hydrolysable polymers may be selected from a group of solvents having low volatility, low toxicity, high inflammation temperature and degradable in the downhole environment. Often, a solvent is used with a vapor pressure of less than about 3 to about 6 Pa at 20° C. and a flammability temperature of greater than about 90° C. The solvent may be from the class of dibasic esters (DBE): DBE-4, DBE-5, DBE-6 and their mixtures. The emulsifier may be a cationic, anionic or nonionic surfactant. In some instances, the fluid is emulsified in a high-speed disperser, a spray injector or a field blender. The NCC or NCC particle stabilizer and the surfactant may be added to the water phase. Also, gelatin, in addition to the NCC or NCC particles, may be added as the emulsion stabilizer. The polymer may be selected such that its hydrolysis in the downhole environment produces a sticky polymer material, and the downhole hydrolysis may be irreversible.

The NCCs and/or NCC particles of the present disclosure may also be used to stabilize the interface in aqueous biphasic systems. NCC has large surface area and this property is helpful in stabilizing emulsions or biphasic systems at the interface, as similar to a Pickering emulsion. Aqueous systems that include two aqueous phases that remain as distinct phases even when placed in direct contact with each other have been known for a number of years. Such systems have been referred to as aqueous biphasic systems and have also been referred to as water-in-water emulsions when one phase is dispersed as droplets within the other. They have been used in some unrelated areas of technology, notably to give texture to foodstuffs, for extraction of biological materials and for the extraction of minerals.

The two phases of an aqueous biphasic composition contain dissolved solutes which are sufficiently incompatible that they cause segregation into two phases. One solute (or one mixture of solutes) is relatively concentrated in one phase and another solute (or mixture of solutes) is relatively concentrated in the other phase. More specifically, one phase may be relatively rich in one solute which is a polymer while the other phase is relatively rich in a solute which is a different polymer (a polymer/polymer system). Other possibilities are polymer/surfactant, polymer/salt, and surfactant/salt. An aqueous biphasic system can also be made with one salt concentrated in one phase and a different salt concentrated the other phase but these are less likely to provide the thickening called for in this application.

Changes to the composition of an aqueous biphasic system, or to prevailing conditions such as pH, can convert the system from two phases to a single phase. An aqueous biphasic system can provide a mobile two-phase fluid of fairly low viscosity, which becomes more viscous on conversion to a single phase. The change to the more viscous single phase state may be brought about underground so that a suitable viscosity can be provided at a subterranean location yet the fluid can be pumped towards that location as a mobile fluid thus enabling a reduction in the energy used to pump the fluid.

An aqueous biphasic mixture may include two phases under surface conditions, which may conveniently be defined as a temperature of 25° C. and a pressure of 1000 mbar. As discussed above, the biphasic composition may comprise a rheology modifying material (i.e., thickening material), such as NCCs and/or NCC particles, which is able to provide an increase in viscosity when added to water. The NCCs and/or NCC particles may be present at a greater concentration in a first phase of the biphasic system than in its second phase, while a second solute or mixture of solutes will be more concentrated in the second phase than in the first phase.

In embodiments, the NCCs and/or NCC particles may be present in a discontinuous phase of the fluid (which may be the first or second phase). In such embodiments, the NCCs and/or NCC particles may have minimal impact on the bulk fluid viscosity. In some embodiments where the first phase is the discontinuous phase, the NCCs and/or NCC particles may be present in the first phase, but the NCCs and/or NCC particles are not present in the second phase. In some embodiments where the second phase is the discontinuous phase, the NCCs and/or NCC particles may be present in the second phase, but the NCCs and/or NCC particles are not present in the first phase.

This second solute (or mixture of solutes) may, for convenience, be referred to as a ‘second partitioning material’ because its presence in addition to the thickening material causes segregation and the formation of the separate phases.

The presence of this second partitioning material and consequent formation of two phases with the nanocellulose (or concentrated in one phase) can, provided the volume of the second phase is sufficient, have the effect of preventing the thickening material from increasing the apparent viscosity of the mixture to the extent which would be observed in a single aqueous phase. The second partitioning material may have the effect of restricting the water solubility of the thickening material. Additional information regarding aqueous biphasic systems is described in U.S. Patent Application Pub. No. 2010/0276150, the disclosure of which is incorporated by reference herein in its entirety.

In embodiments, the fluids, treatment fluids, or compositions of the present disclosure may contain an emulsion stabilizer comprising NCCs and/or NCC particles, the NCCs and/or NCC particles being present in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain an emulsion stabilizer comprising NCCs and/or NCC particles, the NCCs and/or NCC particles being present in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

Transport of Material

The presence of NCCs and/or NCC particles allows for enhanced control over the transport of various materials into the wellbore. NCCs and/or NCC particles may be used to form hydrogen bonding between individual particles, and/or form a structure network generating a high yield stress behavior, which will impart good suspension properties. In embodiments, NCCs and/or NCC particles may be added to a carrier fluid to assist in the aggregation and/or agglomeration of materials in the carrier fluid. Furthermore, the addition of NCCs and/or NCC particles to a carrying fluid, such as, for example, natural based polymers, synthetic polymers, surfactant based solutions, aqueous or non-aqueous based fluids, foam-based fluids may help to suspend polymeric or non-polymeric particles. The addition of NCCs and/or NCC particles to a carrying fluid may also help to suspend non-polymeric particles, such as for example, clay, barite, mineral particles.

In embodiments, the NCCs and/or NCC particles may be included in a pill, such as fluid-loss control pill, to potentially improve the transport of these pills materials will be a possible application. Fluid loss control pills are used in an embodiment to control leak-off of completion brine after perforating and before gravel packing or frac-packing. They are also used in an additional or alternate embodiment to isolate the completion and wellbore fluid after gravel packing by spotting the pill inside the screen. These pills in an embodiment can contain a polyester bridging agent, optionally with or without a viscosifying polymer. If the pill is a fluid-loss control pill, the fluid leak-off to the formation may be used to block the perforations or to form a filtercake on the formation face. In the case of fluid loss through the screen during trip out for assembling the screen and the production tubular, the fluid loss pill is spotted inside the screen to block the openings in the screen. Additional details regarding pills are described in U.S. Pat. Nos. 8,016,040, 8,002,049, 7,947,627, 7,935,662, 7,331,391 and 7,207,388, each of which is incorporated by reference herein in its entirety. The nanocellulose material may be used to improve the transport of proppant in low viscous fluids such as slick water. Additional details regarding slick water treatments are described in U.S. Patent Application Pub. No. 2009/0318313 and U.S. Patent Application Pub. No. 2003/0054962, the disclosures of which are incorporated by reference herein in their entirety.

In embodiments, the fluids, treatment fluids, or compositions of the present disclosure may contain NCCs and/or NCC particles (for assisting with the transport of materials) in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain NCCs and/or NCC particles (for assisting with the transport of materials) in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

Fracture Plugging

Fractures in reservoirs normally have the highest flow capacity of any portion of the reservoir formation. These fractures in the formation may be natural or hydraulically generated. In a natural fault in the rock structure, the high flow capacity results either from the same factors as for natural fractures or from the fracture being open for example due to natural asperities or because the rock is hard and the closure stress is low. In artificially created fractures, such as those created by hydraulic fracturing or acid fracturing, the high flow capacity results from the fracture being either propped with a very permeable bed of material or etched along the fracture face with acid or other material that has dissolved part of the formation.

Fractures of interest in this field may be connected to the subterranean formation and/or to the wellbore. Large volumes of fluids will travel through fractures due to their high flow capacity. This allows wells to have high fluid rates for production or injection. Normally, this is desirable.

However, in the course of creating or using an oil or gas well, it is often desirable to plug or partially plug a fracture in the rock formations, thereby reducing its flow capacity. Reasons for plugging these fractures may include a) they are producing unwanted water or gas, b) there is non-uniformity of injected fluid (such as water or CO₂) in an enhanced recovery flood, or c) expensive materials (such as hydraulic fracturing fluids during fracturing) are being injected into non-producing areas of the formation. This latter case can be particularly deleterious if it results in undesirable fracture growth because it wastes manpower, hydraulic horsepower, and materials, to produce a fracture where it is not wanted, and at worst it results in the growth of a fracture into a region from which undesirable fluids, such as water, are produced.

In embodiments, after well treatment composition is placed in the wellbore or the subterranean formation, at least one plug may be formed in at least one of a perforation, a fracture or the wellbore. The at least one plug is comprised of at least the NCCs and/or NCC particles of the well treatment composition, and may be installed for diversion and/or the isolation of various zones in the wellbore or the subterranean formation. Also, after the placement, the fracture may close on the NCC or NCC particle after the well treatment composition is introduced into the fracture. Furthermore, the plug may be plurality of plugs, thus isolating one or more regions within the subterranean formation or wellbore.

To prevent particle separation and uneven packing during mixing and injection of the NCCs and/or NCC particles, the densities of the NCCs and/or NCC particles should be within about 20% of one another other. Particles are mixed and pumped using equipment and procedures commonly used in the oilfield for cementing, hydraulic fracturing, drilling, and acidizing. These particles may be pre-mixed or mixed on site. They are generally mixed and pumped as a slurry in a carrier fluid such as water, oil, viscosified water, viscosified oil, and slick water (water containing a small amount of polymer that serves primarily as a friction reducer rather than primarily as a viscosifier). In embodiments, the well treatment composition may also comprise a carrier fluid that is not capable of dissolving the NCCs and/or NCC particles.

Unless the particles have a very low density, and/or the carrier fluid has a very high density, and/or the pump rate is very high, the carrier fluid will normally be viscosified in order to help suspend the particles. Any method of viscosifying the carrier fluid may be used. Water may be viscosified with a non-crosslinked or a crosslinked polymer. The polymer, especially if it is crosslinked, may remain and be concentrated in the fracture after the treatment and help impede fluid flow. In fracturing, polymers may be crosslinked to increase viscosity with a minimum of polymer. In embodiments, the more polymer may be better than less, unless cost prevents it, and crosslinking adds cost and complexity, so uncrosslinked fluids can be also desirable, bearing in mind that more viscous fluids tend to widen fractures, which may be undesirable.)

In fracturing, it is desirable for the polymer to decompose after the treatment, so the least thermally stable polymer that will survive long enough to place the proppant is often chosen. In embodiments, stable polymers, such as polyacrylamides, substituted polyacrylamides, and others may be advantageous. The choice of polymer, its concentration, and crosslinker, if any, is made by balancing these factors for effectiveness, taking cost, expediency, and simplicity into account

Placement of the NCC or NCC particle plugging material is similar to the placement of proppant in hydraulic fracturing. The plugging material may be suspended in a carrier fluid to form a “filling slurry”. If a fracture is being created and plugged at the same time, a “Property3D” (P3D) hydraulic fracture simulator may be used to design the fracture job and simulate the final fracture geometry and filling material placement. (If an existing fracture is being plugged, a simulator is not normally used.) Examples of such a P3D simulator are FRACADE (Schlumberger proprietary fracture design, prediction and treatment-monitoring software), FRACPRO sold by Pinnacle Technologies, Houston, Tex., USA, and MFRAC from Meyer and Associates, Inc., USA. Whether a fracture is being created and plugged in a single operation, or an existing fracture is being plugged, the fracture wall should be covered top-to-bottom and end-to-end (“length and height”) with filling slurry where the unwanted fluid flow is expected. Generally, the width of the created fracture is not completely filled with the well treatment composition, but it may be desirable to ensure that enough material is pumped to (i) at a minimum (should the fracture close after placement of the well treatment composition) create a full layer of the largest (“coarse”) size material used across the entire length and height of the region of the fracture where flow is to be impeded, or to (ii) fill the fracture volume totally with well treatment composition. When at least situation (i) has been achieved, the fracture will be said to be filled with at least a monolayer of coarse particles.

The normal maximum concentration utilized may be three layers (between the faces of the fracture) of the coarse material. If the fracture is wider than this, but will close, three layers of the filling material may be used, provided that after the fracture closes the entire length and height of the fracture walls are covered. If the fracture is wider than this, and the fracture will not subsequently close, then either (i) more filling material may be pumped to fill the fracture, or (ii) some other material may be used to fill the fracture, such as but not limited to the malleable material described above. More than three layers may be wasteful of particulate material, may allow for a greater opportunity of inadvertent undesirable voids in the particle pack, and may allow flowback of particulate material into the wellbore. Therefore, especially if the fracture volume filled-width is three times the largest particle size or greater, then a malleable bridging material may be added to reduce the flow of particles into the wellbore. This should be a material that does not increase the porosity of the pack on closure. Malleable polymeric or organic fibers are products that effectively accomplish this. Concentrations of up to about 9.6 g malleable bridging material per liter of carrier fluid may be used.

The carrier fluid may be any conventional fracturing fluid that will allow for material transport to entirely cover the fracture, will stay in the fracture, and will maintain the material in suspension while the fracture closes. Crosslinked guars or other polysaccharides may be used. Examples of suitable materials include crosslinked polyacrylamide or crosslinked polyacrylamides with additional groups such as AMPS to impart even greater chemical and thermal stability. Such materials may (1) concentrate in the fracture, (2) resist degradation, and provide additional fluid flow resistance in the pore volume not filled by particles. Additionally, wall-building materials, such as fluid loss additives, may be used to further impede flow from the formation into the fracture. Wall-building materials such as starch, mica, and carbonates are well known.

Often it is desirable to plug a portion of the fracture; this occurs in particular when the fracture is growing out of the desired region into a region in which a fracture through which fluid can flow is undesirable. This can be achieved using the well treatment composition described above if the area to be plugged is at the top or at the bottom of the fracture. There are two techniques to achieve this; each may be used with either a cased/perforated completion or an open hole completion. In the first (“specific gravity”) technique the bridging slurry is pumped before pumping of the main fracture slurry and has a specific gravity different from that of the main fracture slurry. If the filling slurry is heavier than the main fracture slurry, then the plugged portion of the fracture will be at the bottom of the fracture. If the filling slurry is lighter than the main fracture slurry, then the plugged portion of the fracture will be at the top of the fracture. The filling slurry will be inherently lighter or heavier than the proppant slurry simply because the particles are lighter or heavier than the proppant; the difference may be enhanced by also changing the specific gravity of the carrier fluid for the particles relative to the specific gravity of the carrier fluid for the proppant.

The second (“placement”) technique is to run tubing into the wellbore to a point above or below the perforations. If the aim is to plug the bottom of the fracture, then the tubing is run in to a point below the perforations, and the bridging slurry is pumped down the tubing while the primary fracture treatment slurry is being pumped down the annulus between the tubing and the casing. This forces the filling slurry into the lower portion of the fracture. If the aim is to plug the top of the fracture, then the tubing is run into the wellbore to a point above the perforations. Then, when the filling slurry is pumped down the tubing while the primary fracture treatment slurry is being pumped down the annulus between the tubing and the casing, the filling slurry is forced into the upper portion of the fracture. The tubing may be moved during this operation to aid placement of the particles across the entire undesired portion of the fracture. Coiled tubing may be used in the placement technique.

In embodiments, the fluids, treatment fluids, or compositions of the present disclosure may contain NCCs and/or NCC particles (for forming plugs) in an amount of from about 5 wt % to about 70 wt %, of from about 10 wt % to about 60 wt %, of from about 20 wt % to about 50 wt %, or of from about 30 wt % to about 40 wt % based on the total weight of the fluid, treatment fluid, or composition. In some embodiments, the fluids, treatment fluids, or compositions of the present disclosure may contain NCCs and/or NCC particles (for forming plugs) in an amount of from about 0.001 wt % to about 10 wt %, such as, 0.01 wt % to 10 wt %, 0.1 wt % to 5 wt %, or of from about 0.5 wt % to about 5 wt % based on the total weight of the fluid, treatment fluid, or composition.

The NCCs and/or NCC particles could be functionalized with any of the matierals described above, such that the NCC can act as sensing agent or tracer in one or more of the oilfield or treatment application discussed above. Other functionalities could act on modifying the wettability of rock, which could be useful for enhanced oil recovery (EOR) applications.

The foregoing is further illustrated by reference to the following examples, which are presented for purposes of illustration and are not intended to limit the scope of the present disclosure.

### EXAMPLES

The following experiments were carried out to demonstrate the synergistic effect between different nanocellulose and guar. In the following experiments, sand settling properties and rheological behaviors were measured. In these experiments, the dilution effect of the nanocellulose has been taken into consideration. The different nanocellulose materials used in these experiments are described below in Table 1.

TABLE 1
Description of Nanocellulose Materials

| | Composition of active |
|---|---|
| | component given by |
| Nanocellulose type | supplier |
| MFC 1 | 10 wt. % in DI water |
| MFC 2 | 3 wt. % |
| NCC 1 | 5.7 wt. % in DI water |
| NCC 2 | 95 wt. % solid |

Material Settling

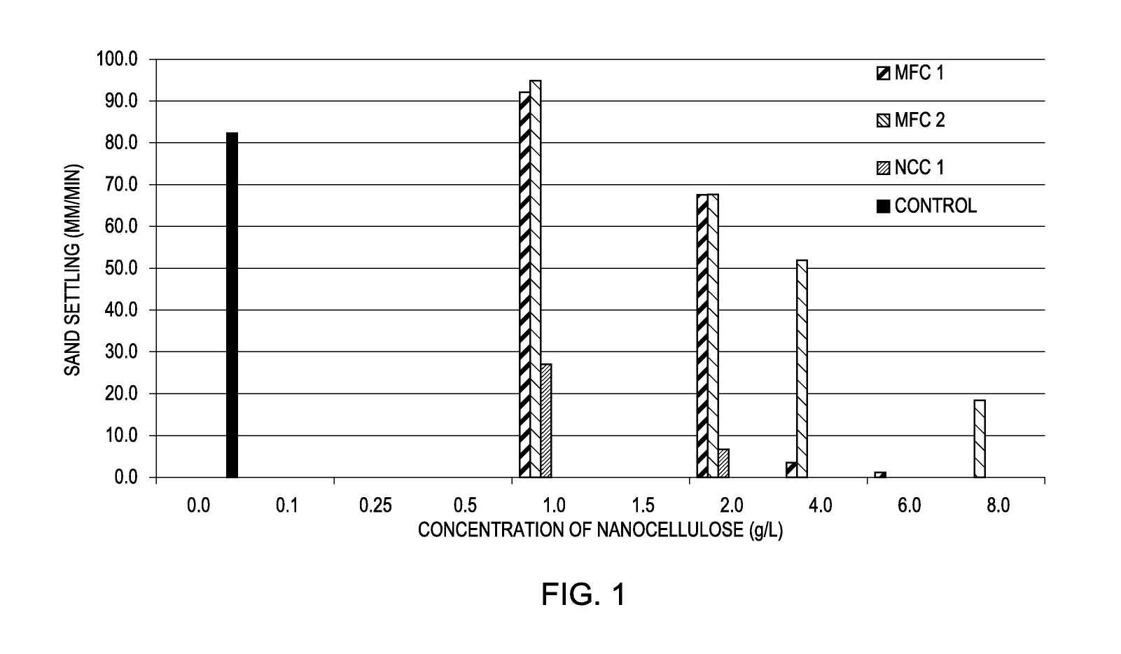

The different nanocellulose materials were initially blended at concentration of 1 gram/Liter (g/L), and also at 2 g/L, with a solution of hydrated guar (3.6 g/L, 30 ppt). The mixture was stirred for 10 minutes at room temperature. The resulting mixture was poured in a volumetric cylinder (25 mL) and single grain of a 20/40 Mesh CARBOLITE proppant was used to measure the static sand settling. Results are shown in FIG. 1 and Table 2, which includes the results from the single grain static sand settling experiments numerous nanocellulose concentrations.

TABLE 2
Single grain static sand settling properties of different linear gels guar-
nanocellulose (mm · min⁻¹) Proppant 20/40 Mesh CARBOLITE

| | Concentration of Nanocellulose (g · L⁻¹) | | | | | | | | | |
|---|---|---|---|---|---|---|---|---|---|---|
| Sample | 0.0 | 0.1 | 0.25 | 0.5 | 1.0 | 1.5 | 2.0 | 4.0 | 6.0 | 8.0 |
| MFC 1 | 82.4 | — | — | — | 92.1 | — | 67.6 | 3.5 | 1.2 | NS |
| Comp. Ex. | | | | | | | | | | |
| MFC 2 | 82.4 | — | — | — | 94.8 | — | 67.6 | 51.9 | — | 18.4 |
| Comp. Ex. | | | | | | | | | | |
| NCC 1 | 82.4 | — | — | — | 27.1 | — | 6.7 | NS | NS | NS |
| guar | 82.4 | — | — | — | — | — | — | — | — | — |
| reference | | | | | | | | | | |
| 3.6 g/L | | | | | | | | | | |

NS = No Settling

The above results demonstrate that the static sand settling can be greatly improved by the addition of nanocellulose. Better results were obtained with NCC 1 relative to the MFC products. For concentration greater than 4 g/L sand suspension was observed for the MFC products.

Additional single grain static sand settling experiments were performed with a concentration of guar of 1.8 g/L (20 ppt). The results are shown in Table 3. As seen in Table 3, a single grain of sand falls with a velocity of about 3000 mm/min in guar alone. When guar is mixed with the nanocellulose samples, the sand settling is reduced to 420 mm/min for NCC 1.

TABLE 3
Single grain static sand settling tests

| | | Single grain Sand |
|---|---|---|
| | | Static Settling in |
| Sample | Charge | mm/min |
| MFC 1 | 2 g/L | 1036 |
| NCC 1 | 2 g/L | 420 |
| Guar | 1.8 g/L | 3000 |

These single grain static sand settling tests demonstrate that the presence of nanocellulose within a guar solution increases the proppant suspension as show above in Table 3 with NCC 1.

Rheology Studies: Blend of Guar with NCC

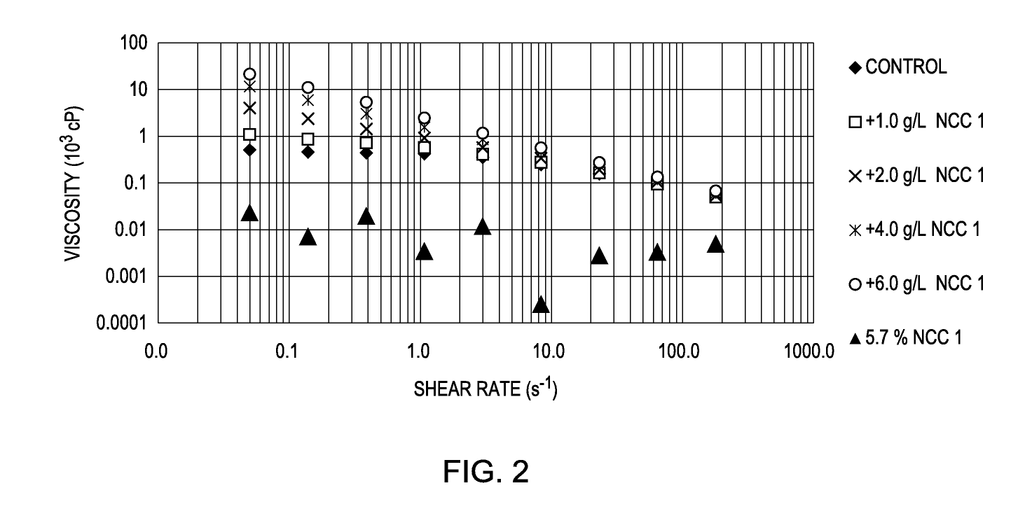

A blend of NCC (at various concentration ranging from 1.0 g/L to 4.0 g/L) and guar at 30 ppt was prepared and subjected to rheological testing using a BOHLIN CVO-R rheometer (manufactured by Malvern Instruments) equipped with a Pelletier device for temperature study. The results of these experiments are shown in FIG. 2. In FIG. 2, the viscosity as a function of shear rates ranging from 0.05 s⁻¹ to 150 s⁻¹ is plotted. Further results from these experiments are presented in Table 4.

TABLE 4
Viscosity (10³ cP) on Linear guar 3.6 g/L - NCC 1

| | Concentration of NCC 1 (g · L⁻¹) | | | | | NCC 1 5.7% in |
|---|---|---|---|---|---|---|
| Shear rate (s⁻¹) | 0.0 | 1.0 | 2.0 | 4.0 | 6.0 | DI water |
| 179.6 | 0.052 | 0.050 | 0.053 | 0.060 | 0.067 | 0.005 |
| 64.6 | 0.092 | 0.094 | 0.104 | 0.119 | 0.133 | 0.003 |
| 23.2 | 0.156 | 0.164 | 0.190 | 0.231 | 0.271 | 0.003 |
| 8.3 | 0.247 | 0.277 | 0.339 | 0.455 | 0.565 | 0.003 |
| 3.0 | 0.351 | 0.412 | 0.568 | 0.856 | 1.16 | 0.012 |
| 1.1 | 0.418 | 0.568 | 0.918 | 1.57 | 2.47 | 0.003 |
| 0.387 | 0.436 | 0.716 | 1.43 | 3.02 | 5.33 | 0.019 |
| 0.139 | 0.459 | 0.856 | 2.35 | 5.96 | 11.1 | 0.007 |
| 0.050 | 0.505 | 1.08 | 4.01 | 11.6 | 21.4 | 0.023 |

Overall, the linear fluid with NCC shows shear thinning properties and high yield stress characterized by a high viscosity at low shear rates. Additionally, the results demonstrate that as the concentration of NCC increased the viscosity at low shear rates increases.

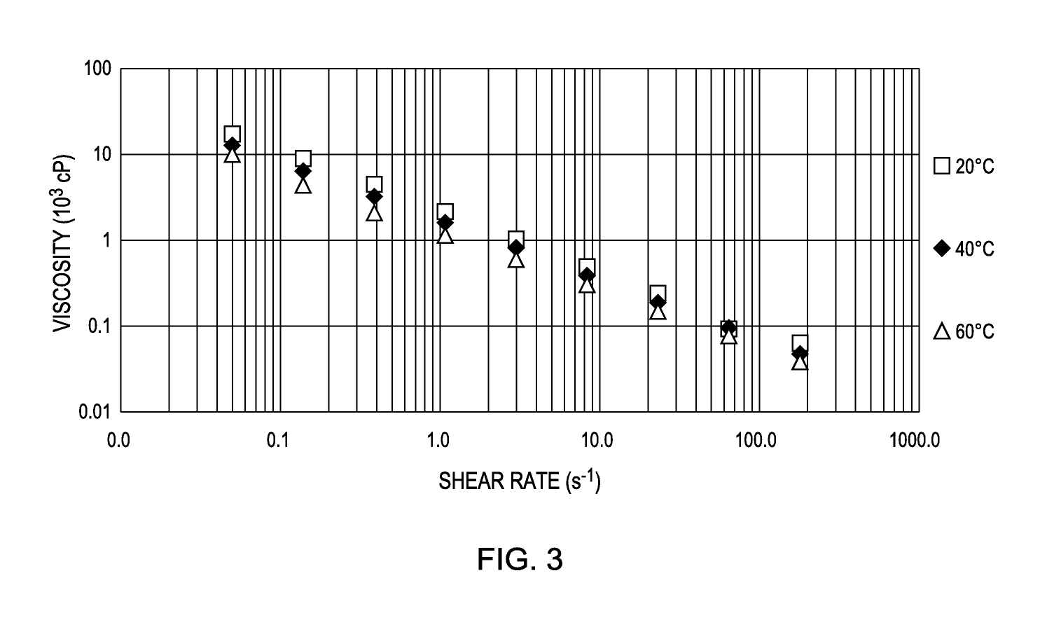

Rheology tests at various temperatures were also performed. The results are presented in FIG. 3 and Table 5.

TABLE 5
Viscosity (10³ cP) on guar 3.6 g/L - NCC 1 6.0 g/L

| | Temperature | | | | | | |
|---|---|---|---|---|---|---|---|
| | 20° C. | | 40° C. | | 60° C. | | |
| | (68° F.) | | (104° F.) | | (140° F.) | | 20° C. |
| Shear | Linear | | Linear | | Linear | | (68° F.) |
| rate | gel + | Ref. | gel + | Ref. | gel + | Ref. | NCC 1 5.7% |
| (s⁻¹) | NCC 1 | guar | NCC 1 | guar | NCC 1 | guar | in DI water |
| 179.6 | 0.063 | 0.046 | 0.047 | 0.037 | 0.038 | 0.032 | 0.005 |
| 64.6 | 0.093 | 0.086 | 0.095 | 0.068 | 0.077 | 0.053 | 0.003 |
| 23.2 | 0.241 | 0.226 | 0.187 | 0.099 | 0.148 | 0.071 | 0.003 |
| 8.3 | 0.492 | 0.217 | 0.386 | 0.137 | 0.301 | 0.095 | 0.003 |
| 3 | 1.03 | 0.293 | 0.817 | 0.174 | 0.593 | 0.103 | 0.012 |
| 1.1 | 2.16 | 0.363 | 1.61 | 0.196 | 1.14 | 0.117 | 0.003 |
| 0.387 | 4.49 | 0.408 | 3.22 | 0.194 | 2.08 | 0.132 | 0.019 |
| 0.139 | 8.93 | 0.428 | 6.38 | 0.188 | 4.35 | 0.123 | 0.007 |
| 0.05 | 17.2 | 0.512 | 12.7 | 0.098 | 9.95 | 0.257 | 0.023 |

As shown above in FIG. 3 and Table 5, the viscosity is higher with the presence of NCC 1 showing the synergistic effect of the two polymers. The results indicate that the presence of NCC affords much higher viscosities especially at lower shear rates.

Hydrated CMC/NCC Mixture

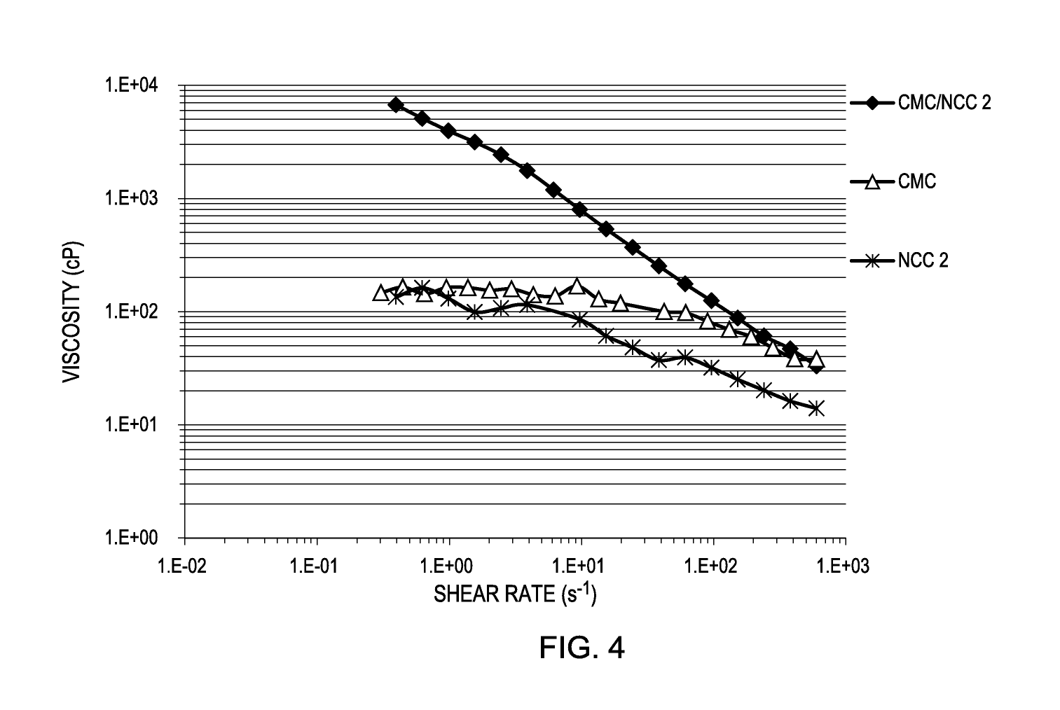

NCC 2 was mixed in tap water containing 2% KCl, from a pre-hydrated solution in DI water, to make a 0.96 wt % NCC 2 solution. The mixture was mixed for 5 minutes at about 4000 rpm to ensure proper dispersion in solution. To this solution was then added carboxylmethylcellulose (CMC) to make a 0.48 wt % CMC solution. The mixture was then mixed for 30 minutes. A further sample containing hydrated CMC in tap water and 2% KCl was prepared in a similar matter to make a 0.48 wt % CMC solution. Additionally, a NCC 2 sample at 0.96 wt % was prepared. Viscosity measurements were then recorded as discussed above. The results are shown in FIG. 4.

The mixture of NCC 2 and CMC (2:1 weight ratio) in 2% KCl solution displays a much higher viscosity and shear thinning gel like behavior. These experiments also demonstrate the formation of a high yield stress at low shear rates (around 1 s⁻¹). The difference in viscosity between the CMC/NCC sample and the other two samples approached two orders of magnitude.

### Rheology with MFC 1

### Comparative Example

Linear guar at 3.6 g/L (20 ppt) was mixed with MFC 1 and the solution was agitated for 10 minutes. Rheology experiments were conducted a various MFC 1 concentrations within the range of 4 g/L to 6 g/L. The results of the rheology experiments are reported below in Table 6. Table 6 also includes the rheology data for NCC 1 as concentrations of 4.0 g/L and 6.0 g/L as previously presented above in Table 4.

TABLE 6
Rheology with MFC 1 and NCC 1

| | Reference | +4.0 g/L | +6.0 g/L | +4.0 NCC | +6.0 NCC |
|---|---|---|---|---|---|
| | Guar | MFC1 | MFC1 | 1 g/L | 1 g/L |
| Shear | Viscosity | Viscosity | Viscosity | Viscosity | Viscosity |
| Rate (s⁻¹) | (Pa · s) | (Pa · s) | (Pa · s) | (Pa · s) | (Pa.s) |
| 499.8 | 0.030 | 0.021 | 0.001 | — | — |
| 179.6 | 0.052 | 0.060 | 0.058 | 0.060 | 0.067 |
| 64.6 | 0.092 | 0.117 | 0.117 | 0.119 | 0.133 |
| 23.2 | 0.156 | 0.218 | 0.220 | 0.231 | 0.271 |
| 8.3 | 0.247 | 0.399 | 0.426 | 0.455 | 0.565 |
| 3.0 | 0.351 | 0.707 | 0.810 | 0.856 | 1.16 |
| 1.1 | 0.418 | 1.218 | 1.536 | 1.57 | 2.47 |
| 0.387 | 0.436 | 2.073 | 2.961 | 3.02 | 5.33 |
| 0.139 | 0.459 | 3.569 | 5.750 | 5.96 | 11.1 |
| 0.050 | 0.505 | 6.052 | 11.256 | 11.6 | 21.4 |

The results demonstrated that the shear thinning properties of the MFC 1 fluid were not comparable to NCC 1 in the low shear region below about a shear rate of 8.3 s⁻¹. Based upon this information, one may conclude that NCC or NCC particles has an improved yield stress which correlates to an improvement in the material's capability in suspending various solid materials, such as proppant.

Crosslinked Gels

Gellant is poured into DI water and the sample is mixed for half an hour. 3 g/L NCC 1 was then poured into a blender and mixed for 10 minutes. NaOH concentrated was added in an amount sufficient to reach a pH of 10.5. Boric acid was then injected to perform crosslinking. The final concentration of borate ions was fixed at 40 ppm in the guar solution. Viscometry was performed with a Bohlin C-VOR OCP 271-03 device, tool C25 Din 53019. A pre-shear at a shear rate of 1 s⁻¹ was applied for 60 s⁻¹.

Viscosity measurements were carried out after crosslinking and are reported in Table 7.

TABLE 7
Rheology with NCC 1/Borate Crosslinker
Shear rate = 0.1 s⁻¹

| | Borate | |
|---|---|---|
| | crosslinked | Crosslinked |
| | guar with | guar |
| | NCC 1 | reference |
| Time | Viscosity | Viscosity |
| (s) | (Pas) | (Pas) |
| 10.004 | 7.28E+01 | 2.72E+01 |
| 30.008 | 1.35E+02 | 2.46E+01 |
| 50.008 | 1.85E+02 | 2.20E+01 |
| 70.008 | 1.94E+02 | 2.01E+01 |
| 90.009 | 1.56E+02 | 1.86E+01 |
| 110.008 | 1.33E+02 | 1.75E+01 |
| 130.007 | 1.30E+02 | 1.66E+01 |
| 150.008 | 1.41E+02 | 1.59E+01 |
| 170.009 | 1.24E+02 | 1.53E+01 |
| 190.008 | 7.65E+01 | 1.48E+01 |

Visco-Elastic Surfactants and Nanocellulose

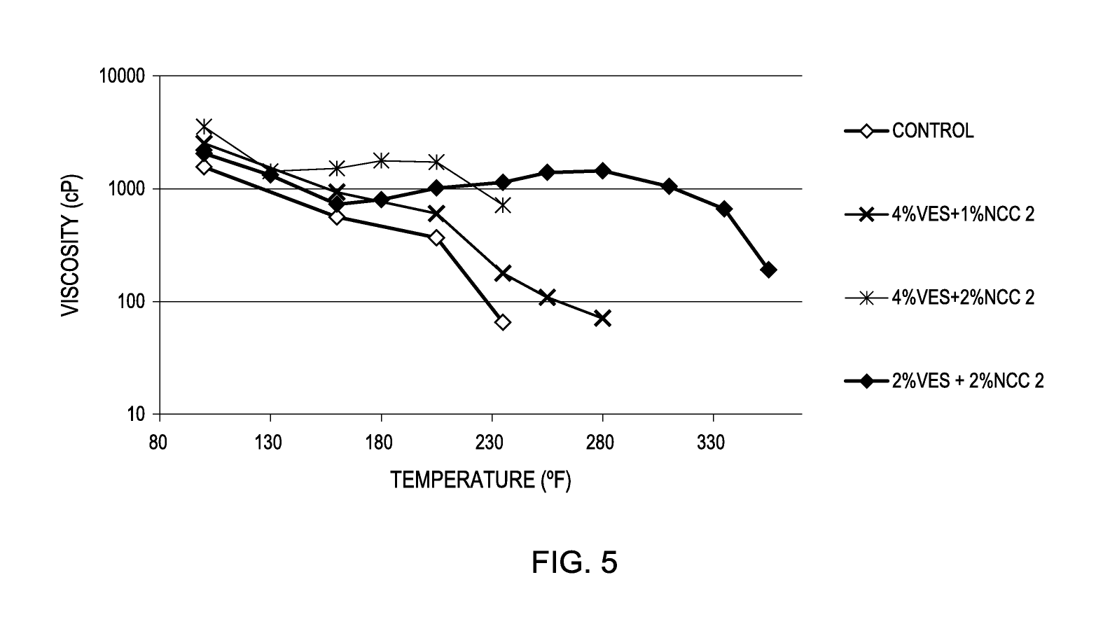

NCC 2 was mixed with DI water to reach the concentrations set forth in FIG. 5. A viscoelastic surfactant (betaine type) was added to the solution and the mixture was sheared in a waring blender at 40% max speed for 3 minutes. The foamed obtained was then subjected to centrifugation in order to proceed with rheology measurements,

After the viscos-elastic surfactants were mixed with NCC 2, the rheology was measured as a function of temperature and shear rates. As demonstrated by the results illustrated in FIG. 5, the addition of NCC 2 increases the thermal stability of the VES from 230° F. (110° C.) to 280° F. (138° C.). Similar trends were observed at higher shear rates. The ratio of VES to NCC2 may be used to optimize the synergistic effect between the two systems.

Gravel Packing Fluid Using a Visco-Elastic Surfactant

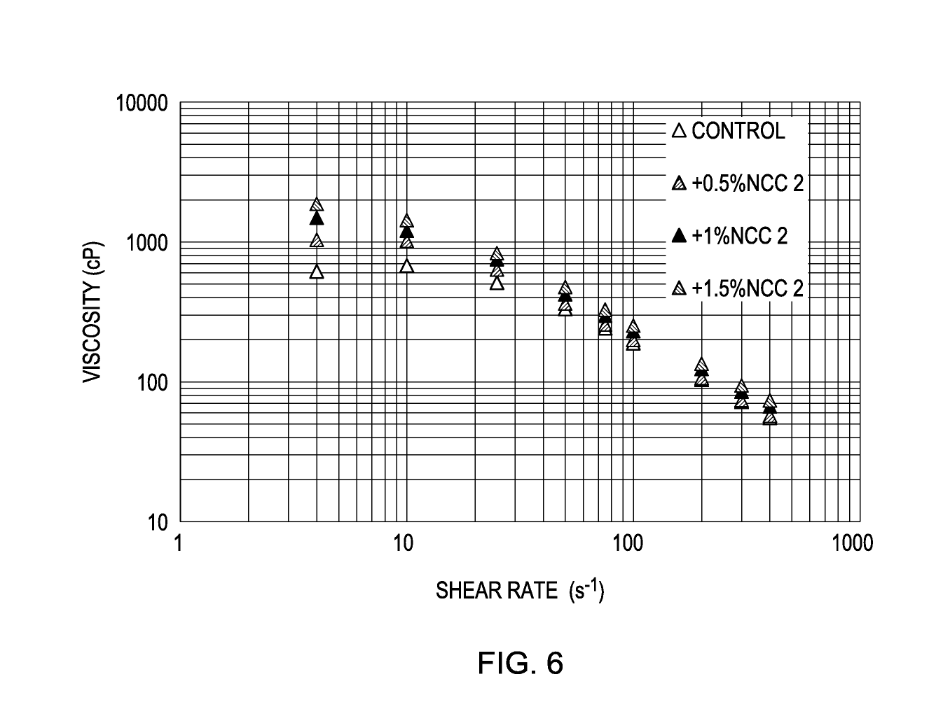

A carrier fluid is composed of 7.5% viscoelastic surfactant in 8.7 pounds per gallon potassium Chloride salt was prepared. Various amounts of NCC 2 (0.5 wt %, 1 wt % and 1.5 wt %) was added to this fluid. The rheology was measured as a function of temperature and shear rates. The results are shown in FIG. 6.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed is:

1. A fluid for treating a subterranean formation comprising:
a solvent; and
a composition comprising a nanocrystalline cellulose.

2. The fluid for treating the subterranean formation of claim 1, wherein the nanocrystalline cellulose comprises rod-like nanocrystalline cellulose particles (NCC particles) having a crystalline structure.

3. The fluid for treating the subterranean formation of claim 2, wherein the NCC particles have a length of about 100 to about 1000 nm, and an aspect ratio (length:diameter) of about 10 to about 100.

4. The fluid for treating the subterranean formation of claim 2, wherein the NCC particles have a diameter of from about 2 to about 100 nm, and an aspect ratio (length:diameter) of about 10 to about 100.

5. The fluid for treating the subterranean formation of claim 1, wherein the fluid is selected from the group consisting of a fracturing fluid, well control fluid, well kill fluid, well cementing fluid, acid fracturing fluid, acid diverting fluid, a stimulation fluid, a sand control fluid, a completion fluid, a wellbore consolidation fluid, a remediation treatment fluid, a drilling fluid, a spacer fluid, a frac-packing fluid, water conformance fluid and gravel packing fluid.

6. The fluid for treating the subterranean formation of claim 1, wherein the nanocrystalline cellulose is a functionalized nanocrystalline cellulose having a percent surface functionalization of from about 5 to about 90 percent.

7. The fluid for treating the subterranean formation of claim 2, wherein the surface of the NCC particles comprises one or more functional groups selected from the group consisting of a hydroxyl, halides, ethers, aldehydes, keytones, esters, amines, amides, sulfate esters, and carboxylates.

8. The fluid for treating the subterranean formation of claim 2, wherein an outer circumference of the NCC particles has been subjected to a chemical modification selected from the group consisting of esterification, etherification, oxidation, silylation, phosphonation, amination, sulfurization, halogenation and polymer grafting.

9. The fluid for treating the subterranean formation of claim 1, wherein the fluid further comprises a hydratable polymer.

10. A method for treating a subterranean formation comprising:
introducing the fluid of claim 1 into a subterranean formation.

11. The method for treating a subterranean formation of claim 10, wherein the fluid further comprises rod-like nanocrystalline cellulose particles (NCC particles) having a crystalline structure.

12. The method for treating a subterranean formation of claim 11, wherein the NCC particles are non-agglomerated and substantially uniformly dispersed in an aqueous solvent.

13. The method for treating a subterranean formation of claim 10, wherein the fluid is a slurry.

14. The method for treating a subterranean formation of claim 10, wherein the fluid further comprises at least one functional additive selected from the group consisting of fly ash, a silica compound, a fluid loss control additive, an emulsion, latex, a dispersant, an accelerator, a retarder, a salt, mica, sand, a fiber, a formation containing agent, fumed silica, bentonite, a microsphere, a carbonate, barite, hematite, an epoxy resin and a curing agent.

15. The method for treating a subterranean formation of claim 10, wherein the fluid further comprises a hydratable polymer.

16. The method for treating a subterranean formation of claim 10, wherein the fluid is an aqueous fluid.

17. The method for treating a subterranean formation of claim 10, wherein the fluid further comprises one or more additives selected from the group consisting of crosslinkers, biocides, surfactants, activators, stabilizers and breakers.

18. The method for treating a subterranean formation of claim 10, wherein the fluid is selected from the group consisting of a fracturing fluid, well control fluid, well kill fluid, well cementing fluid, acid fracturing fluid, acid diverting fluid, a stimulation fluid, a sand control fluid, a completion fluid, a wellbore consolidation fluid, a remediation treatment fluid, a spacer fluid, a drilling fluid, a frac-packing fluid, water conformance fluid and gravel packing fluid.

19. The method for treating a subterranean formation of claim 11, wherein a surface of the NCC particles comprises one or more functional groups selected from the group consisting of a hydroxyl group, sulfate ester groups, and carboxylate groups.

20. The method for treating a subterranean formation of claim 11, wherein the NCC particles possess a chemical and thermal stability such that less than 5% mass deterioration or decomposition occurs when the NCC particles are exposed to downhole conditions.

21. The method for treating a subterranean formation comprising:
preparing a treatment fluid comprising at least:
a solvent, and
a nanocrystalline cellulose; and
introducing the treatment fluid into a wellbore.

22. The method for treating a subterranean formation of claim 21, wherein the treatment fluid further comprises a viscosifying agent comprising rod-like nanocrystalline cellulose particles (NCC particles) having a crystalline structure.

23. The method for treating a subterranean formation of claim 21, wherein the treatment fluid further comprises:
a proppant, and
a proppant transport agent comprising rod-like nanocrystalline cellulose particles (NCC particles) having a crystalline structure.

24. The method for treating a subterranean formation of claim 21, wherein the treatment fluid further comprises a material strengthening agent comprising rod-like nanocrystalline cellulose particles (NCC particles) having a crystalline structure.

25. The method for treating a subterranean formation of claim 21, wherein the treatment fluid further comprises a fluid loss reducing agent comprising rod-like nanocrystalline cellulose particles (NCC particles) having a crystalline structure.

26. The method for treating a subterranean formation of claim 21, wherein the treatment fluid further comprises a friction reducer/drag reduction agent comprising rod-like nanocrystalline cellulose particles (NCC particles) having a crystalline structure.

27. The method for treating a subterranean formation of claim 21, wherein the treatment fluid further comprises a gas mitigation agent comprising rod-like nanocrystalline cellulose particles (NCC particles) having a crystalline structure.

28. The method for treating a subterranean formation of claim 21, wherein the treatment fluid is a stabilized foamed cement slurry.

29. The method for treating a subterranean formation of claim 28, wherein introducing the stabilized foamed cement slurry comprises rod-like nanocrystalline cellulose particles (NCC particles) having a crystalline structure.
